(19) United States
(12) Patent Application Publication
(10) Pub. No.: US 2006/0083485 A1
(43) Pub. Date: Apr. 20, 2006

(54) Information medium, recording method, playback method, recording apparatus, and playback apparatus for digital stream signal

(76) Inventor: Shinichi Kikuchi, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/230,623

(22) Filed: Sep. 21, 2005

(30) Foreign Application Priority Data
Oct. 19, 2004 (JP) 2004-304844

(51) Int. Cl. H04N 5/781

(52) U.S. Cl. 386/95; 386/125

(57) ABSTRACT

A disc configured to record a digital stream signal including multi-view video picture data and the like is used. This disc has a management area and data area. The data area is configured to store the multi-view video picture data and the like as multi-angle data, and the management area is configured to store management information required to manage the recording contents of the data area.

### CROSS-REFERENCE TO RELATED APPLICATIONS

This application is based upon and claims the benefit of priority from prior Japanese Patent Application No. 2004-304844, filed Oct. 19, 2004, the entire contents of which are incorporated herein by reference.

### BACKGROUND OF THE INVENTION

1. Field of the Invention

The present invention relates to an information medium (or data structure), information recording/playback method, and information recording/playback apparatus, which are suited to record/play back a digital stream signal used in digital TV broadcasting or the like.

2. Description of the Related Art

In recent years, TV broadcasting has entered the digital era with programs of high-definition AV information as principal broadcast content. Current satellite digital broadcasting (and terrestrial digital broadcasting which is already in service) adopts an MPEG2 transport stream (abbreviated as MPEG-TS or as simply TS as needed hereinafter). In the field of digital broadcasting using moving pictures, MPEG-TS is expected to be a standard format now and in the future. At the start of such digital TV broadcasting, market needs for a digital recorder that can directly record digital TV broadcasting content is increasing.

As an example of a digital recorder that utilizes an optical disc such as a DVD-RAM, the recording/playback apparatus disclosed in Jpn. Pat. Appln. KOKAI Publication No. 6-225239 is known.

Digital broadcasting can multiplace different programs. Using this mechanism, a multi-view video picture (or rain attenuation broadcast) can be transmitted on a single broadcast channel. Currently, many DVD video recorders are used to record digital broadcasts. A conventional DVD video recorder can record one multi-view video picture, but cannot simultaneously record two or more multi-view video pictures.

### BRIEF SUMMARY OF THE INVENTION

An information medium according to an embodiment of the present invention has a management area and a data area, the data area is configured to store a multi-view picture (and/or rain attenuation broadcast) as multi-angle data, and the management area is configured to store management information used to manage the recording content of the data area.

### BRIEF DESCRIPTION OF THE SEVERAL VIEWS OF THE DRAWING

FIG. 1 is a view for explaining the data structure according to an embodiment of the present invention;

FIG. 2 is a view for explaining the relationship between a playback management information layer, object management information layer, and object layer in the data structure according to the embodiment of the present invention;

FIG. 3 is a block diagram for explaining an example of an apparatus for recording and playing back AV information (digital TV broadcast program including a multi-view video picture, or rain attenuation broadcast) on and from an information recording medium (optical disc, hard disc, or the like) using the data structure according to the embodiment of the present invention;

FIG. 4 is a view for explaining an overview upon converting a digital broadcast transport stream (MPEG-TS) into a DVD program stream (MPEG-PS);

FIG. 5 is a view for explaining a case wherein multi-view (or rain attenuation) data of a digital TV broadcast is converted into multi-angle data of DVD-video (high-definition compatible), and the converted data is recorded/played back;

FIG. 6 is a view for explaining a case wherein multi-view (or rain attenuation) data of a digital TV broadcast is recorded as seamless angle data of DVD-video and as non-seamless angle data;

FIG. 7 is a view for explaining an example of the data structure upon converting multi-view data into seamless angle data of DVD-video (an audio stream is common to respective views);

FIG. 8 is a flowchart for explaining an example of the operation upon converting multi-view data into seamless angle data of DVD-video (an audio stream is common to respective views);

FIG. 9 is a view for explaining an example of the data structure upon converting multi-view data into non-seamless angle data of DVD-video (audio streams are appended to respective views);

FIG. 10 is a flowchart for explaining an example of the operation upon converting multi-view data into non-seamless angle data of DVD-video (audio streams are appended to respective views);

FIG. 11 is a view for explaining a case wherein one view data is selected from multi-view (or rain attenuation) data and is recorded/played back (an example of high-definition compatible DVD-video);

FIG. 12 is a flowchart for explaining an example of the operation upon converting one view data of multi-view data into DVD-video;

FIG. 13 is a view for explaining a case wherein multi-view (or rain attenuation) data of a digital TV broadcast is converted into a plurality of DVD-video recording streams (high-definition compatible), and the converted streams are recorded/played back;

FIG. 14 is a view for explaining an example of the structure of video objects in the case of FIG. 13 (an example that records a plurality of streams for respective packs in a nested structure);

FIG. 15 is a view for explaining an example of the data structure (configuration 1 of management information) upon converting multi-view data into the DVD-video recording format;

FIG. 16 is a view for explaining an example of the data structure (configuration 2 of management information) upon converting multi-view data into the DVD-video recording format;

FIG. 17 is a flowchart for explaining an example of the operation upon converting multi-view data into the DVD-video recording format (an example using a plurality of streams);

FIG. 18 is a view for explaining a case wherein one view data is selected from multi-view (or rain attenuation) data and is recorded/played back (an example of high-definition compatible DVD-video recording);

FIG. 19 is a flowchart for explaining another example of the operation upon converting multi-view data into the DVD-video recording format (an example that records one selected view in one stream);

FIG. 20 is a view for explaining an example of the structure of video objects when multi-view (or rain attenuation) data of a digital TV broadcast is converted into a plurality of DVD-video recording (high-definition compatible) streams, and the converted streams are recorded/played back;

FIG. 21 is a flowchart for explaining still another example of the operation upon converting multi-view data into the DVD-video recording format;

FIG. 22 is a view for explaining an example of how to record management information (control information) and the like of a digital broadcast in the DVD-video format;

FIG. 23 is a view for explaining an example of how to record management information (control information) and the like of a digital broadcast in the DVD-video recording format;

FIG. 24 is a view for explaining the configuration of ILVU used in the embodiment of the present invention; and

FIG. 25 is a view for explaining the configuration of an ENV pack used in the embodiment of the present invention.

### DETAILED DESCRIPTION OF THE INVENTION

An information medium, recording method, playback method, recording apparatus, and playback apparatus of a digital stream signal according to an embodiment of the present invention will be described hereinafter with reference to the accompanying drawings.

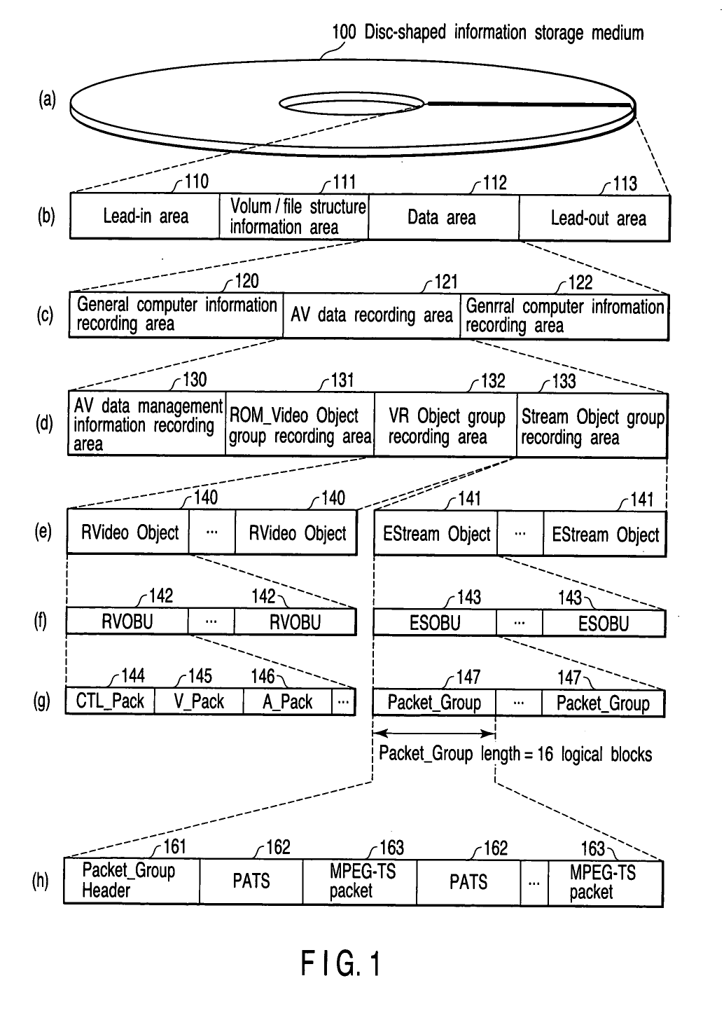

FIG. 1 is a view for explaining the data structure according to an embodiment of the present invention. As disc-shaped information recording medium 100 (FIG. 1(a)), recordable optical discs such as a DVD-RAM, DVD-RW, and DVD-R using a red laser, next-generation HD_DVD-RAM, HD_DVD-RW, and HD_DVD-R using violet to blue lasers, and the like, and recordable magnetic discs such as a hard disc are available. The following explanation will be given taking an optical disc such as a DVD-RAM or the like using a laser of 405 nm to 650 nm as an example.

Disc 100 has lead-in area 110, volume/file structure information area 111, data area 112, and lead-out area 113 from its inner periphery side toward its outer periphery side (FIG. 1(b)). Volume/file structure information area 111 stores a file system. The file system includes information indicating the recording locations of files. Recorded contents are stored in data area 112 (FIG. 1(c)).

Data area 112 is divided into areas 120 that record general computer data, and area 121 that records AV data. AV data recording area 121 includes AV data management information area 130 that stores a file (VMG file) used to manage AV data, ROM video object group recording area 131 (option) that records object data files of the current- or next-generation DVD-video standard, VR object group recording area 132 that records object data (VOBS) files (VRO files) complying with the video recording standard, and stream object group recording area 133 that records stream objects compatible with digital broadcasting (FIG. 1(d)).

In this embodiment, when a digital broadcasting stream is digitally recorded via digital-to-analog to analog-to-digital conversion or a TS is converted into a PS and that PS is recorded, it is recorded as VR objects (FIG. 1(e)). On the other hand, when a digital broadcast stream is stream-recorded intact (or it is re-encoded as digital data and is digitally recorded), it is recorded as stream objects 131 as files independently of VR objects 140 (FIG. 1(e)).

Each VR object 140 is formed of one or more data units (RVOBU) 142 serving as access units to disc 100 (FIG. 1(f)). Likewise, each stream object 141 is formed of one or more data units (expanded stream object units: ESOBU) 143 serving as access units to disc 100 (FIG. 1(f)). One ESOBU is a data unit which is designated by the values in object management information and is delimited by pictures at given time intervals. Alternatively, one ESOBU may be a data unit delimited by one or more GOPs.

Each RVOBU 142 includes control pack 144, video pack 145, audio pack 146, and the like, which comply with an MPEG program stream (MPEG-PS). On the other hand, each ESOBU 143 is made up of one or more packet groups 147 each of which includes a group of TS packets complying with an MPEG transport stream (MPEG-TS) (FIG. 1(g)).

In this embodiment, each packet group 147 includes a group of, e.g., 16 packs (or 16 logical blocks LB) (or the number of packs or logical blocks may be 32 and the like). If one pack size (or one LB size) is 2 kbytes, the size of each packet group 147 is 32 kbytes. This size equals the ECC block size in the video recording standard (when 32 packs or 32 logical blocks are adopted in another standard, the ECC block size is 64 kbytes).

Each packet group 147 forms a packet recording area (DVD-TS packet recording area) in stream recording (SR) (FIG. 1(h)). This DVD-TS packet recording area can include packet group header 161, and a plurality of pairs (e.g., 170 pairs) of packet arrival time information (PATS) 162 and MPEG-TS packets 163.

If one pack group is configured to include arrival time information (Packet Arrival Time: PAT) for first TS packet 163, the arrival time information of each of subsequent TS packets 163 may be expressed by difference time information (Incremental PAT) from the preceding TS packet.

In the structure shown in FIG. 1, an embodiment using disc 100 in which AV data recording area 121 is configured by only VR object group recording area 132 and its management information recording area 130 without the ROM video object recording area 131 and stream object group recording area 133 is also available.

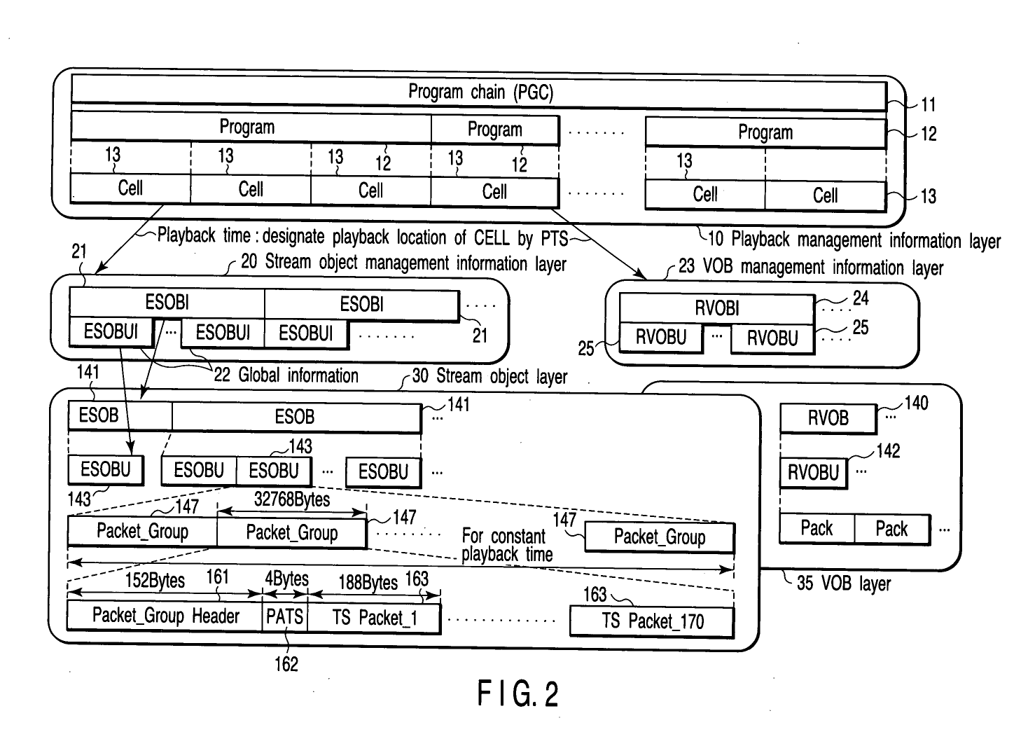

FIG. 2 is a view for explaining the relationship among a playback management information layer, object management information layer, and object layer in the data structure according to the embodiment of the present invention. Management information (VMG file) recorded in AV data management information recording area 130 in FIG. 1 has playback management information layer 10 used to manage the playback sequences of both the recorded contents based on the video recording standard and the stream recording recorded contents. That is, a group of one or more cells 13 each of which serves as a playback unit of stream-recorded objects form program 12, and a group of one or more cells 13 each of which serves as a playback unit of video-recorded objects form another program 12. A sequence (playback sequence) of these programs 12 is managed by management information (PGCI) of program chain (PGC) 11.

Even when the user wants to start playback from the middle of either cell 13 on the stream recording side or cell 13 on the video recording side, he or she can designate the playback location using a playback time (PTS). That is, when playback is to start from the middle of cell 13 on the stream recording side using the playback time (PTS), stream object ESOB 141 in stream object layer 30 is designated via stream object information ESOBI 21 in stream object management information layer 20, and stream object unit ESOBU 143 in stream object layer 30 is designated via stream object unit information ESOBUI 22 in stream object management information layer 20. When ESOB 141 and its ESOBU 143 are designated, the playback start location is specified. (ESOBUI in this case may be restated as global information 22.)

This ESOBU 143 is formed of one or more packet groups 147. ESOBU 143 is a data unit corresponding to, e.g., one or more GOPs. Alternatively, ESOBU 143 may be delimited by units each corresponding to a data size for a given playback time designated by a value in object management information. In this way, overflow of each information field is prevented.

Each packet group 147 includes 16 packs (or 16 LBs) (32768 bytes), and has packet group header 161 at its head position. After packet group header 161, a plurality of pairs (170 pairs in this example) of PATS 162 and TS packets 163 are allocated. These TS packets 163 store stream recording recorded contents.

On the other hand, when playback is to start from the middle of cell 13 on the video recording side using the playback time (PTS), video object RVOB 140 in video object layer 35 is designated via video object information RVOBI 24 in video object (VOB) management information layer 23, and video object unit RVOBU 142 in video object layer 35 is designated via video object unit information RVOBUI 25 in video object management information layer 23. When RVOB 140 and its RVOBU 142 are designated, the playback start location is specified. RVOBU 142 includes a plurality of packs 38, which store video recording recorded contents.

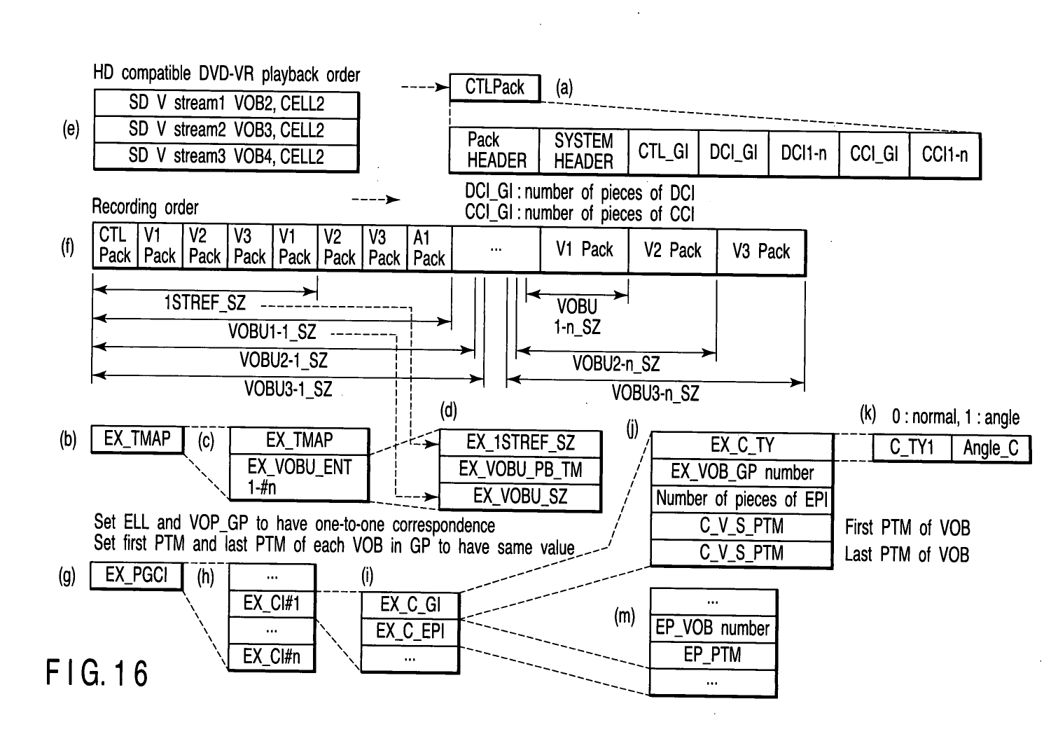

When playback is to start from the middle of cell 13 on the stream recording side, the playback start location can be designated using a time by the number of fields by ESOBU playback time information (not shown). On the other hand, when the playback is to start from the middle of cell 13 on the video recording side, the playback start location can be designated by RVOBU playback time information (corresponding to EX_VOBU_PB_TM in EX_TMAP in FIG. 16 to be described later) in time map information (TMAPI) specified by the video recording standard.

The contents of FIG. 2 can be summarized as follows. That is, the structure of each SOBS (Stream Object Set) includes one or more ESOBs (extended stream objects). Each ESOB corresponds to, e.g., one program. The ESOB includes one or more ESOBUs (extended stream object units), each of which corresponds to object data for a given time interval or one or more GOPs.

When the transfer rate is low, one GOP cannot often be sent within 1 sec (1s) (DVD-VR that MPEG-encodes an analog video input inside the apparatus can freely set the data unit configuration since it adopts internal encoding, but digital broadcast cannot specify the next incoming data since encoding is done by a broadcast station). On the other hand, the transfer rate may be high, and I-picture data may be sent frequently. In such case, ESOBU is delimited frequently, and ESOBU management information increases accordingly, thus ballooning the whole management information. For this reason, it is appropriate to delimit ESOBUs according to the embodiment of the present invention by a given time interval (a minimum limitation is to delimit ESOBUs by pictures except for the last ESOBU of the ESOB) or by one or more GOPs.

One ESOBU includes one or more packet groups, each of which is basically formed of 16 packs (one pack=one sector: 2048-byte size). Each packet group includes a packet group header and (170) TS packets. The arrival time of each TS packet can be detected from PATS 162 which forms a pair with each TS packet 163.

The management information (file system) will be described below. Data in disc 100 in FIG. 1 includes volume/file structure information area 111 which stores a file system, and data area 112 which actually records data files. The file system stored in volume/file structure information area 111 includes information indicating the recording locations of files. Data area 112 is divided into areas 120 that record general computer data, and area 121 that records AV data. AV data recording area 121 includes AV data management information area 130 that stores a VMG file (and its backup file) used to manage recorded AV data, VR object group recording area 132 that records object data files (VRO files) complying with the video recording standard, and the like.

Note that different directories are prepared in correspondence with formats (e.g., VIDEO-TS for DVD-Video (ROM Video) and DVD-RTAV for DVD-RTR (DVD-VR), and the Hi-Vision digital broadcast compatible DVD standard is recorded in, e.g., a DVD_HDVR directory. Although not shown, the DVD_HDVR directory records an HDVMG file (HR_MANGER.IFO and its backup HR_MANGER.BUP) used to manage data, a VRO file (HR_MOVIEO.VRO) as an object file used to record analog AV information such as an analog broadcast, analog line input data, and the like, an SRO file (HR_STRMx.SOR; x=0, 1, 2, . . . ) as a digital broadcast object, a still object file (HR_STILL.VRO), and an audio object file (HR_AUDIO.VRO). Note that the SRO file records SOBS.

Furthermore, as an example, a time map file (HR_TMAP.IFO) and its backup file (HR_TMAP.BUP) (neither are shown) can also be assured as independent files. These files (HR_TMAP.IFO and HR_TMAP.BUP) can store information of a time map table TMAPT (that is, TMAPT can undergo file management independently of other kinds of management information).

SR management data is recorded in the HDVMG file common to VR, and undergoes control common to VR. As shown in FIG. 2, SR and VR management data are linked for respective CELLs, and their playback locations can be designated by playback times.

Note that the DVD_HDVR directory can store HR_THNL.DAT (not shown) as a thumbnail (reduced-scale picture) file which can be used in a chapter menu and the like. Furthermore, the DVD_HDVR directory can store an additional text file: HR_TEXT.DAT independent from item text (IT_TXT) and HR_EXEP.DAT used to save information added to entry points (EP), as needed (neither of them are shown). Moreover, a method of adding TMAPT to the end of HDVR_VMG in place of storing TMAPT as an independent file is available.

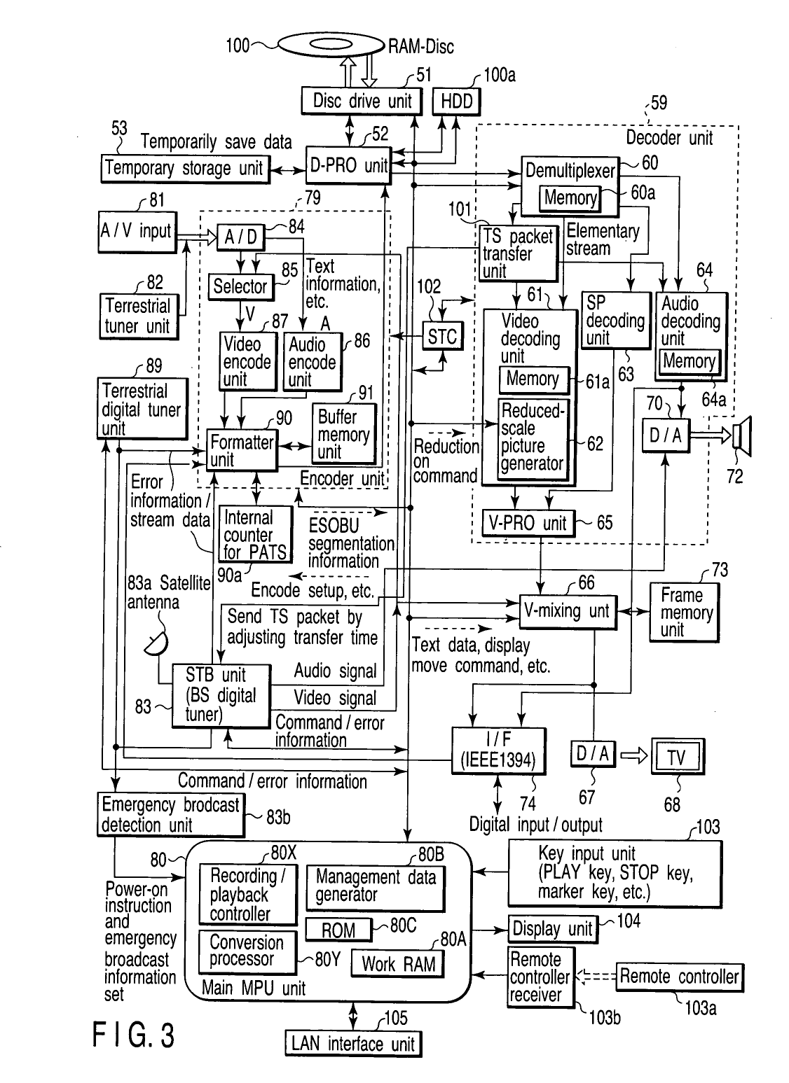

FIG. 3 is a block diagram for explaining an example of the apparatus which records and plays back AV information (digital TV broadcast program or the like including multi-view data or rain attenuation broadcast) on an information recording medium (optical disc, hard disc, or the like) using the data structure according to the embodiment of the present invention. As shown in FIG. 3, this apparatus (digital video recorder/streamer) comprises MPU unit 80, key input unit 103, remote controller receiver 103b for receiving user operation information from remote controller 103a, display unit 104, decoder unit 59, encoder unit 79, system time counter (STC) unit 102, data processor (D-PRO) unit 52, temporary storage unit 53, disc drive unit 51 for recording/playing back information on/from recordable optical disc 100 (e.g., a DVD-RAM, DVD-RW, DVD-R, or the like), hard disc drive (HDD) 100a, video mixing (V-mixing) unit 66, frame memory unit 73, analog TV digital-to-analog converter 67, analog TV tuner unit 82, terrestrial digital tuner unit 89, STB (Set Top Box) unit 83 connected to satellite antenna 83a, emergency broadcast detection unit 83b, and the like. Furthermore this apparatus comprises digital interface 74 (e.g., IEEE 1394) to support digital inputs/outputs as a streamer. Note that STC unit 102 counts clocks on a 27-MHz basis in correspondence with PAT_Base.

STB unit 83 decodes received digital broadcast data to generate an AV signal (digital). STB unit 83 sends the AV signal to TV 68 via encoder unit 79, decoder unit 59, and digital-to-analog converter 67 in the streamer, thus displaying the contents of the received digital broadcast. Alternatively, STB unit 83 directly sends the decoded AV signal (digital) to V-mixing unit 66, and can send an analog AV signal from it to TV 68 via digital-to-analog converter 67.

The apparatus shown in FIG. 3 forms a recorder comprising both the video and stream recording functions. Hence, the apparatus comprises components (IEEE 1394 interface 74 and the like) which are not required in video recording, and those (AV input analog-to-digital converter 84, audio encoding unit 86, video encoding unit 87, and the like for AV input 81) which are not required in stream recording.

Encoder unit 79 includes analog-to-digital converter 84, video encoding unit 87, input selector 85 to video encoding unit 87, audio encoding unit 86, a sub-picture encoding unit (as needed although not shown), format unit 90, internal counter 90a for the packet arrival time (PATS), and buffer memory unit 91.

Decode unit 59 comprises demultiplexer 60 which incorporates memory 60a, video decoding unit 61 which incorporates memory 61a and reduced-scale picture (thumbnail or the like) generator 62, sub-picture (SP) decoding unit 63, audio decoding unit 64 which incorporates memory 64a, TS packet transfer unit 101, video processor (V-PRO) unit 65, and audio digital-to-analog converter 70. An analog output (an audio signal such as a monaural, stereo, or AAC 5.1CH surround signal) from this digital-to-analog converter 70 is input to an AV amplifier or the like (not shown) to drive a required number of loudspeakers 72.

In order to display on TV 68 contents whose video recording is in progress, stream data to be recorded is sent to decoder unit 59 simultaneously with D-PRO unit 52, and can be played back. In this case, MPU unit 80 makes setups upon playback in decoder unit 59, which then automatically executes a playback process.

D-PRO unit 52 forms ECC groups by combining, e.g., every 16 packs (or 32 packs or 64 kbytes), appends ECC data to each group, and sends them to disc drive unit 51. When disc drive unit 51 is not ready to record on disc 100, D-PRO unit 52 transfers the ECC groups to temporary storage unit 53 and waits until disc drive unit 51 is ready to record. When disc drive unit 51 is ready, D-PRO unit 52 starts recording. As temporary storage unit 53, a large-capacity memory is assumed since it must hold recording data for several minutes or longer by high-speed access. Temporary storage unit 53 may be assured by using a given area of HDD 100a. Note that MPU unit 80 can make read/write access to D-PRO unit 52 via a dedicated microcomputer bus, so as to read/write the file management area and the like.

The apparatus shown in FIG. 3 assumes optical disc 100 such as DVD-RAM/-RW/-R/Blue media (recordable media using blue laser) and the like as primary recording media, and hard disc drive (HDD) 100a (and/or a large-capacity memory card (not shown) or the like) as its auxiliary storage device.

These plurality of types of media can be used as follows. That is, stream recording is done on HDD 100a using the data structure (format) shown in FIG. 1. Of stream recording contents which are recorded on HDD 100a, programs that the user wants to preserve directly undergo stream recording (direct copy or digital dubbing) on disc 100 (if copying is not inhibited by copy control information CCI). In this manner, only desired programs having quality equivalent to original digital broadcast data can be recorded together on disc 100. Furthermore, since the stream recording contents copied onto disc 100 exploit the data structure of the present invention, they allow easy special playback processes such as time search and the like, although these contents are recorded by stream recording.

A practical example of a digital recorder having the aforementioned features (a streamer/video recorder using a combination of DVD-RAM/-RW/-R/Blue media and HDD) is the apparatus shown in FIG. 3. The digital recorder shown in FIG. 3 is configured to roughly include a tuner unit (82, 83, 89), disc unit (100, 100a), encoder unit 79, decoder unit 59, and a controller (80).

Satellite digital TV broadcast data is delivered from a broadcast station via a digital broadcast satellite. The delivered digital data is received and played back by STB unit 83. This STB 83 expands and plays back encrypted data on the basis of a key code distributed from the broadcast station. At this time, encrypted data from the broadcast station is encrypted. Data is encrypted to prevent users who are not subscribers of the broadcast station from illicitly receiving broadcast programs.

In STB unit 83, the broadcast digital data is received by a tuner system (not shown). When the received data is directly played back, it is encrypted by a digital expansion unit and is decoded by an MPEG decoder unit. Then, the decoded received data is converted into a TV signal by a video encoder unit, and that TV signal is externally output via digital-to-analog converter 67. In this manner, the digital broadcast program received by STB unit 83 can be displayed on analog TV 68.

Terrestrial digital broadcast data is received and processed in substantially the same manner as satellite broadcast data except that it does not go through a direct broadcast satellite (and is not encrypted if it is a free broadcast program). That is, terrestrial digital broadcast data is received by terrestrial digital tuner unit 89, and the decoded TV signal is externally output via digital-to-analog converter 67 when it is directly played back. In this way, a digital broadcast program received by terrestrial digital tuner unit 89 can be displayed on analog TV 68. Terrestrial analog broadcast data is received by terrestrial tuner unit 82, and the received analog TV signal is externally output when it is directly played back. In this way, an analog broadcast program received by terrestrial tuner unit 82 can be displayed on analog TV 68.

An analog video signal input from external AV input 81 can be directly output to TV 68. Also, after the analog video signal is temporarily converted into a digital signal by analog-to-digital converter 84, and that digital signal is then re-converted into an analog video signal by digital-to-analog converter 67, that analog video signal may be output to the external TV 68 side. With this arrangement, even when an analog VCR playback signal that includes many jitter components is input from external AV input 81, an analog video signal free from any jitter components (that has undergone digital time-base correction) can be output to the TV 68 side.

A digital video signal input from digital interface (IEEE 1394 interface) 74 is output to the external TV 68 side via digital-to-analog converter 67. In this way, a digital video signal input to digital interface 74 can be displayed on TV 68.

A bitstream (MPEG-TS) input from satellite digital broadcast, terrestrial digital broadcast, or digital interface 74 can undergo stream recording in stream object group recording area 133 (FIG. 1(d)) of disc 100 (and/or HDD 100a) as stream object 141 in FIG. 1(e). An analog video signal from terrestrial analog broadcast or AV input 81 can undergo video recording on VR object group recording area 132 (FIG. 1(d)) of disc 100 (and/or HDD 100a).

Note that the apparatus may be configured to temporarily digitize an analog video signal from terrestrial analog broadcast or AV input 81 into a digital signal, and to make stream recording (SR) of the digital signal in place of video recording (VR). Conversely, the apparatus may be configured to make video recording of a bitstream (MPEG-TS) input from satellite digital broadcast, terrestrial digital broadcast, or digital interface 74 (after it undergoes required format conversion) in place of stream recording.

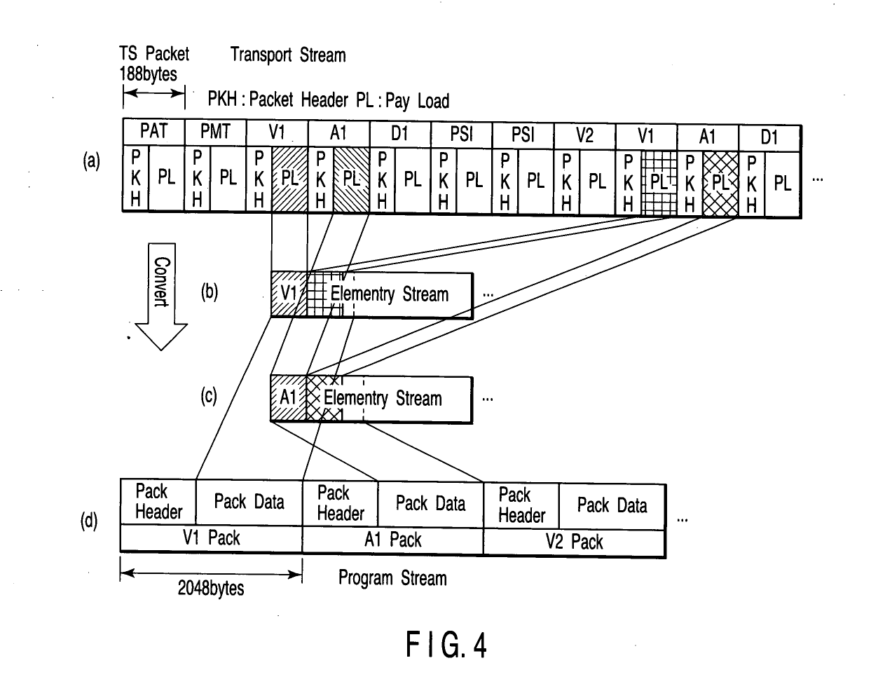

Recording/playback control of stream recording or video recording is done by firmware (control programs and the like) written in ROM 80C of main MPU unit 80 (recording/playback controller 80X, conversion processor 80Y). MPU unit 80 has management data generation unit 80B for stream recording and video recording, generates various kinds of management information using work RAM 80A as a work area, and records the generated management information on AV data management information recording area 130 in FIG. 1(d) as needed. MPU unit 80 plays back management information recorded on AV data management information recording area 130, and executes various kinds of control (FIGS. 4 to 23) on the basis of the played back management information. Of these kinds of control, firmware of a process for converting multi-view or rain attenuation broadcast of a digital broadcast into multi-angle data or a multi-stream (in this case, MPEG-TS is converted into MPEG-PS) is stored in conversion processor 80Y. Note that manufacturer ID information and the like of the apparatus shown in FIG. 3 can be written on ROM 80C of MPU unit 80.

The features of medium 100 (100a) (FIG. 1) used in the apparatus of FIG. 3 will be briefly summarized below. That is, this medium has management area 130 and at least one of data areas 131 to 133. Data is separately recorded on the data area as a plurality of object data (RVOB, ESOB), and each object data includes a group of data units (RVOBU, ESOBU). A VR-based data unit (RVOBU) records a digital signal as a plurality of packets in accordance with MPEG-PS. On the other hand, an SR-based data unit (SOBU) records an MPEG-TS compatible digital broadcast signal by converting that signal into packet groups for respective TS packets (see FIG. 1). (Or a method of recording stream packs each including an application group corresponding to a plurality of TS packets is available. In this case, an application packet is allowed to be segmented into partial application packets at the boundary of neighboring stream packs.) Management area 130 has PGC information (PGCI) as information used to manage the playback sequence. This PGC information includes cell information (CI). Furthermore, management area 130 has information used to manage object data (RVOB, ESOB).

The apparatus shown in FIG. 3 can make stream recording on medium 100 (100a) with the above data structure in addition to video recording (for example, video recording can be executed on optical disc 100 during stream recording on HDD 100a). In this case, in order to extract program map table PMT and service information SI from a TS packet stream, MPU unit 80 has a service information extraction unit (not shown; firmware that forms management data generation unit 80B). Also, MPU unit 80 has an attribute information generation unit (not shown; firmware that forms management data generation unit 80B) that generates attribute information (PCR_pack number, PCR_LB count number, and the like) on the basis of information extracted by the service information extraction unit.

In the apparatus shown in FIG. 3, the flow of signals upon recording is, for example, as follows. That is, TS packet data received by STB unit (or terrestrial digital tuner) 83 are packed into packet groups by formatter unit 90 and the packet groups are saved on a work area (buffer memory unit 91). When the saved packet groups reach a predetermined size (for one or an integer multiple of CDA size), they are recorded on disc 100 and/or 100a. As the operations to be executed at that time, upon reception of TS packets, a group is formed every 170 packets, and a packet group header is generated.

On the other hand, an analog signal input from the terrestrial tuner or line input is digitized by analog-to-digital converter 84. That digital signal is input to respective encoder units. That is, a video signal is input to video encoding unit 87, an audio signal is input to audio encoding unit 86, and text data of, e.g., teletext broadcasting is input to an SP (sub-picture) encoding unit (not shown). The video signal is compressed by MPEG, the audio signal is compressed by AC3 or MPEG audio (or not compressed as linear PCM), and the text data is compressed by runlength coding.

Multi-view data (MPEG-TS) or the like received by the digital tuner (STB) is converted into multi-angle data (MPEG-PS) or the like, and is sent to formatter 90 (details of this conversion process will be described later).

Each encoder unit packs compressed data (or segments into blocks) to form 2084-byte packets (or blocks) and inputs them to formatter unit 90. Formatter unit 90 multiplexes the packets (or blocks), and sends them to D-PRO unit 52. D-PRO unit 52 forms ECC blocks for every 16 or 32 packets (16 or 32 blocks), appends error correction data to them, and records the ECC packets (or blocks) on disc 100 (or HDD 100a) via disc drive unit 51.

When disc drive unit 51 is busy due to seek, track jump, and the like, data are stored in buffer unit 53, and wait until disc drive unit 51 is ready. Furthermore, formatter unit 90 generates segmentation information during video recording, and periodically sends it to MPU unit 80 (GOP head interrupt or the like). The segmentation information includes the number of packs (or the number of LBs) of RVOBU (ESOBU), the end address of I-picture data from the first RVOBU (ESOBU), the playback time of RVOBU (ESOBU), and the like.

In the flow of signals upon playback, data are read out from disc 100 via disc drive unit 51, undergo error correction by D-PRO unit 52, and are then input to decoding unit 59. MPU unit 80 determines the type of input data (i.e., VR or SR data) (based on cell type), and sets that type in decoder unit 59 before playback. In case of SR data, MPU unit 80 determines PMT_ID to be played back based on cell information CI to be played back, determines the PIDs of items (video, audio, and the like) to be played back based on that PMT, and sets them in decoder unit 59. In decoder unit 59, the demultiplexer sends TS packets to the respective decoding units (61 to 64) based on the PIDs. Furthermore, the TS packets are sent to TS packet transfer unit 101, and are transmitted to STB unit 83 (and IEEE 1394 interface 74) in the form of TS packets. Decode unit 61 executes decoding, and decoded data are converted into an analog signal by digital-to-analog converter 67, thus displaying data on TV 68. In case of VR data, demultiplexer 60 sends data to the respective decode units (61 to 64) according to the fixed IDs. Decode unit 61 executes decoding, and decoded data are converted into an analog signal by digital-to-analog converter 67, thus displaying data on TV 68.

Upon playback, pack data read out from disc 100 or 100a are interpreted by demultiplexer 60. Packs that store TS packets are sent to TS packet transfer unit 101, and are then sent to respective decoding units (61 to 64), thus playing back data. When pack data are transferred to STB unit 83 (or are transmitted to an external apparatus such as a digital TV or the like (not shown) via IEEE 1394 interface 74 and the like), TS packet transfer unit 101 transfers only TS packets at the same time intervals as they arrive. STB unit 83 makes decoding to generate an AV signal, and outputs it to the external TV or the like via the video encoder unit in the streamer.

An MPEG-TS scheme as a basic format common to broadcast schemes which broadcast (distribute) compressed moving picture data such as digital TV broadcast, broadcast uses a wired network such as the Internet or the like, and so on is divided into a packet management data field and payload. The payload includes data to be played back in an encrypted state. According to ARIB (Association of Radio Industries and Businesses) as the digital broadcast scheme in Japan, a PAT (Program Association Table), PMT (Program Map Table), and SI (Service Information) are not encrypted. Also, various kinds of management information can be generated using the PMT and SI (SDT: Service Description Table, EIT: Event Information Table, BAT: Bouquet Association Table).

The contents to be played back of a digital broadcast include MPEG video data, Dolby AC3® audio data, MPEG audio data, data broadcast data, and the like. Also, the contents include information required upon playback (e.g., PAT, PMT, SI, and the like) although they are not directly related to the contents to be played back. The PAT includes the PID (Packet Identification) of the PMT for each program, and the PMT records the PIDs of video data and audio data.

A normal playback sequence of the STB (Set Top Box) is as follows. That is, when the user determines a program based on EPG information, the PAT is loaded at the start time of the target program, and the PID of a PMT, which belongs to the desired program, is determined on the basis of that data. The target PMT is read out in accordance with that PIT, and the PIDs of video and audio packets to be played back, which are included in the PMT, are determined. Video and audio attributes are read out based on the PMT and SI and are set in respective decoders (61 to 64). The video and audio data are extracted and played back in accordance with their PIDs. Note that the PAT, PMT, SI, and the like are transmitted at intervals of several 100 ms since they are also used during playback.

Different digital broadcast schemes are adopted in different countries: for example, DVB (Digital Video Broadcasting) in Europe; ATSC (Advanced Television Systems Committee) in U.S.A.; and ARIB mentioned above in Japan.

In DVB, the video format is MPEG2, the resolutions are 1152*1440i, 1080*1920(i, p), 1035*1920, 720*1280, (576, 480)*(720, 544, 480, 352), and (288, 240)*352, the frame frequencies are 30 Hz and 25 Hz, the audio format includes MPEG-1 audio and MPEG-2 Audio, and the sampling frequencies are 32 kHz, 44.1 kHz, and 48 kHz.

In ATSC, the video format is MPEG2, the resolutions are 1080*1920(i, p), 720*1280p, 480*704(i, p), and 480*640(i, p), the frame frequencies are 23.976 Hz, 24 Hz, 29.97 Hz, 30 Hz, 59.94 Hz, and 60 Hz, the audio format includes MPEG1 Audio Layer 1 & 2 (DirecTV) and AC3 Layer 1 & 2 (Prime star), and the sampling frequencies are 48 kHz, 44.1 kHz, and 32 kHz.

In ARIB, the video format is MPEG2, the resolutions are 1080i, 720p, 480i, and 480p, the frame rates are 29.97 Hz and 59.94 Hz, the audio format includes AAC (MPEG-2 AUDIO), and the sampling frequencies are 48 kHz, 44.1 kHz, 32 kHz, 24 kHz, 22.05 kHz, and 16 kHz. Furthermore, one feature of digital broadcasting in Japan lies in “a plurality of video pictures [being] delivered at the same time (by time sharing), and a required one of these video pictures [being] selected and played back to select a plurality of contents according to a user's preference and the like”.

Currently, DVD has prevailed as video media. Especially, as the video format, DVD-video is widespread as video that is marketed, and the generation is changing from tape media to DVD. Furthermore, DVD-RAM and DVD-RW are increasingly prevalent as recording media, and have momentum of sweeping video cassette tapes (VCR). The recording format at that time is the DVD-VR format. In addition, DVD-R as a write-once medium which is compatible to DVD-ROM video is gaining popularity. This is because when recording is done on DVD-R using the DVD-video format, that medium can be played back by a widespread DVD player, and family and friends can have recorded programs in common.

There are needs for recording digital broadcast data on DVD-R, DVD-RAM, or the like using the conventional DVD-VR format. In such a case, since the digital broadcast data is delivered using transport stream TS, that stream is converted into program stream PS. As a result, TS packet headers inserted in the TS every 188 bytes are removed, and recording can be efficiently done.

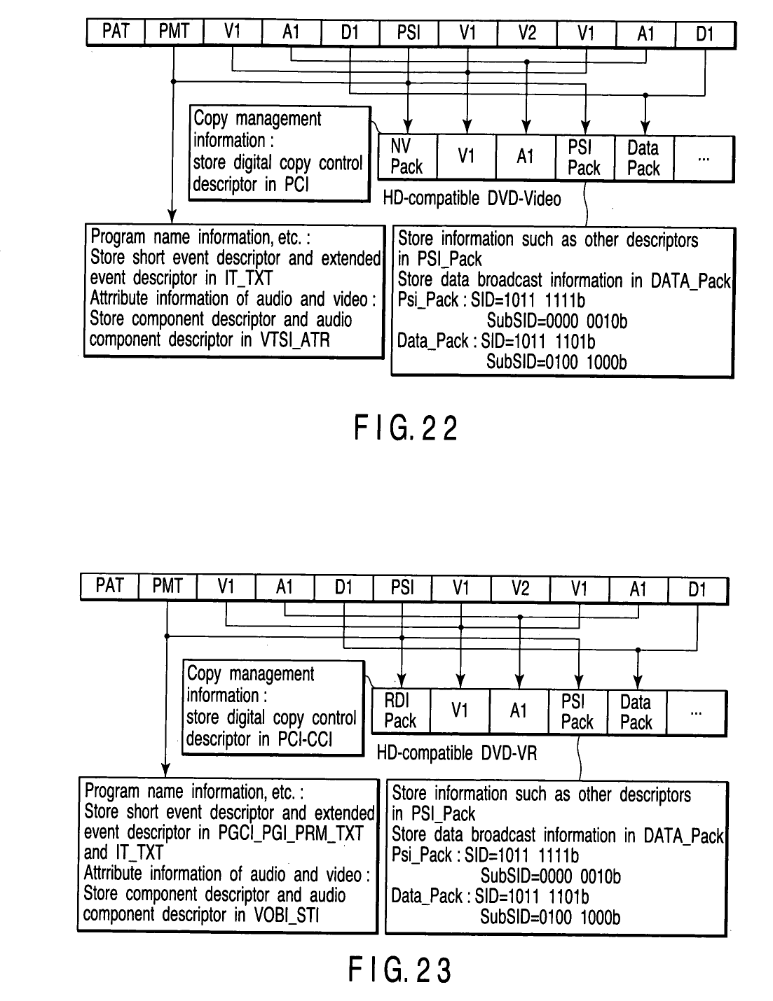

However, the problem arises in SI (Service Information) and PSI (Program Specific Information) as information unique to digital broadcasting, and multi-view broadcast (and rain attenuation broadcast) as functions unique to digital broadcasting. The embodiment of the present invention solves this problem by making multi-angle (multi-stream) recording of multi-view broadcast (rain attenuation broadcast) and adding unique packets (see FIGS. 22 and 23) upon recording SI and PSI.

In the DVD format, (one or more) management information files of video data and (one or more) video data files are separately recorded on the data area of a disc with a general file system. Each management information file includes attribute information indicating the attributes of objects, EX_PGC information (EX_PGCI) indicating the playback sequence, and RVOB information (RVOBI) indicating the save location of objects. Hence, the playback order is determined according to EX_PGCI, the playback position is determined according to RVOBI, and playback is made according to the attribute information. Furthermore, as for playback units, a title is made up of program chains (PGC), each PGC is made up of programs (PG), and each PG is made up of cells (CELL). Object RVOB is made up of RVOBU, which includes one or more video packs, audio packs, sub-picture packs, and the like to have a control pack (CTR_Pack or NV_Pack) at its head position.

Normally, a DVD is recorded using a program stream (PS) of the MPEG system layer. This PS is prepared to be used upon being recorded on a recording device (recording media), and can be recorded more efficiently on a disc. (Note that TS is prepared for transmission/reception, and has error correction performance and the like superior to PS.) When a digital broadcast is recorded on DVD, TS must be converted into PS. This conversion will be explained below.

FIG. 4 is a view for explaining an overview upon converting a digital broadcast transport stream (MPEG-TS) into a DVD program stream (MPEG-PS). FIG. 4 shows the “sequence for converting TS into PS” required upon recording digital broadcast on a DVD disc or the like as objects. More specifically, a plurality of pieces of payload information (PL of video V1 and that of audio A1 in the example of FIG. 4(a)) of packets of respective objects (e.g., video and audio objects) are collected to form an elementary stream (see FIG. 4(b) and (c)). The formed elementary stream is segmented anew into packets of a program stream (PS), and the packets are packed every 2048 bytes (one pack=2048 bytes in DVD), as shown in FIG. 4(d), to be converted into MPEG-PS, which is saved on DVD.

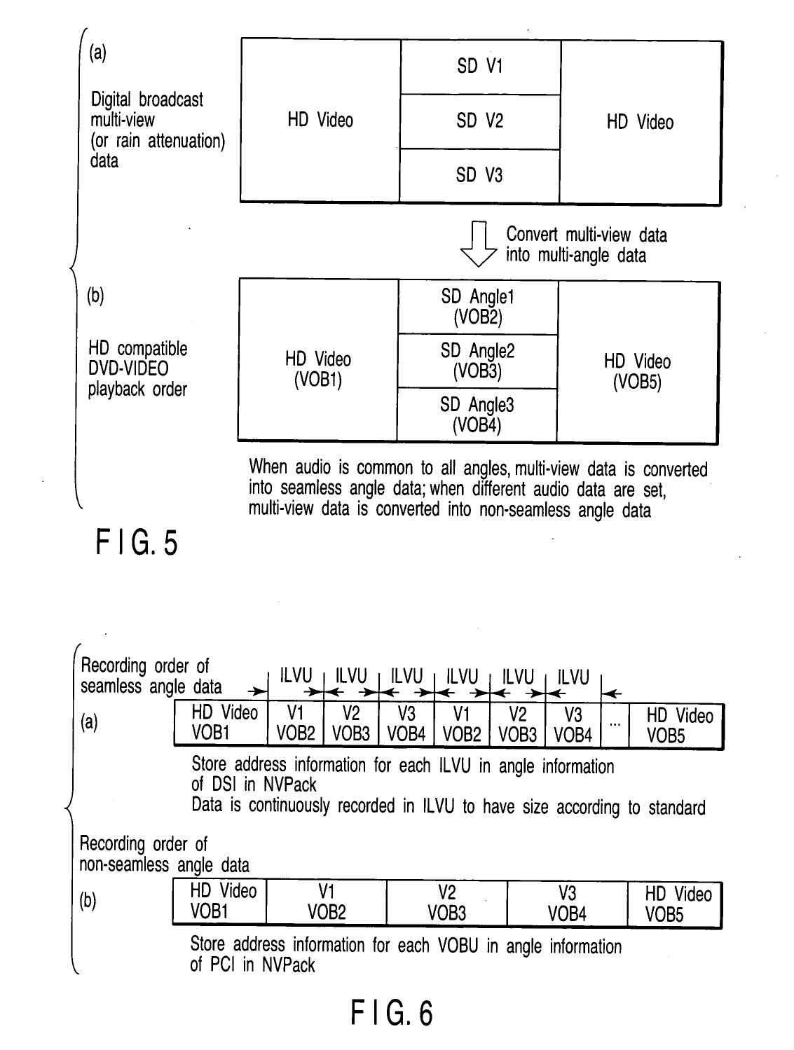

FIG. 5 is a view for explaining a case wherein multi-view (or rain attenuation) data of a digital TV broadcast is converted into multi-angle data of DVD-video (high-definition compatible), and the converted data is recorded/played back. FIG. 6 is a view for explaining a case wherein multi-view (or rain attenuation) data of a digital TV broadcast is recorded as seamless angle data of a DVD-video and as non-seamless angle data.

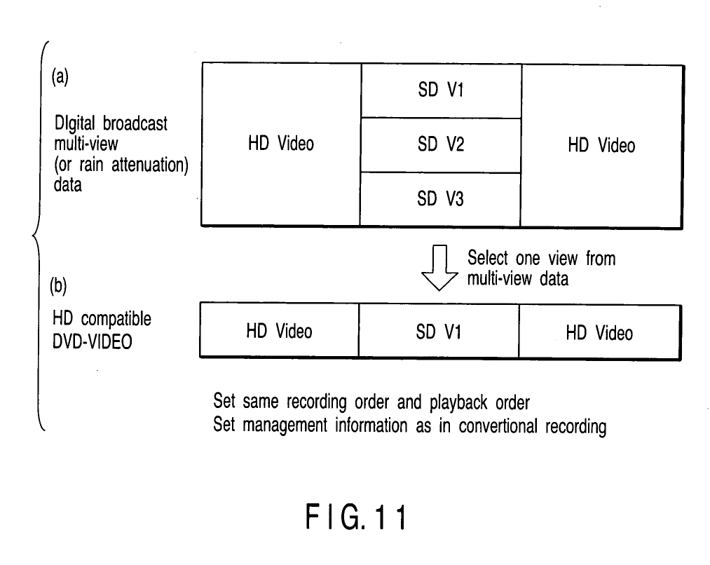

Upon converting multi-view broadcast into DVD-video data and saving the converted data, two methods are available. The first method saves multi-view broadcast as multi-angle (angle cell) data, as shown in FIGS. 5(a) and (b) (the second embodiment will be explained later with reference to FIG. 11). In this case, this method can be further classified into two methods, i.e., those for seamless angle and non-seamless angle data. Seamless and non-seamless angle data can be classified depending on whether or not an audio stream is common to respective views (in ether of seamless/non-seamless angle data, an audio stream is recorded every view).

When an audio stream is common to respective views, even when a video picture is switched to any view, since the flow of audio remains the same, multi-view data can be recorded as seamless angle data. For example, when multi-view video pictures of a given piano concert include up video picture 1 of the face of a pianist (SD V1 in FIG. 5(a)), keyboard video picture 2 on the right hand side (SD V2 in FIG. 5(a)), and keyboard video picture 3 on the left hand side (SD V3 in FIG. 5(a)), a single piano performance is played back in all of video pictures 1 to 3. In this case, it is natural to seamlessly switch video pictures to be observed by the viewer in synchronism with piano performance tones which are also played back seamlessly independently any of video pictures 1 to 3 to be displayed.

Upon recording video pictures 1 to 3 as seamless angle data, recording of video picture 1 (VOB1) to video picture 3 (VOB3) on a disc uses interleaved units (ILVU), as shown in FIG. 6(a). Each ILVU includes one or more video object units (VOBU). This ILVU is the same as that used in video recording of seamless angle cells in the existing read-only DVD-video. (The jump destination ILVU address upon seamless angle switching is described in data search information DSI of a navigation pack allocated at the head of each VOBU. The ILVU has a size which allows playing back it seamlessly, and to frequently switch angles.)

On the other hand, when an audio stream is not common to respective views, non-seamless angle is selected. For example, in multi-view pictures of a given health program, conversation audio data of both a performer and guest doctor are appended to video picture 1, explanatory audio data about target illness is appended to video picture 2 as that of an anatomical chart in the body, and explanatory audio data about the outer appearance of a medicine to be taken and dosage of that medicine is appended to video picture 3. In this case, audio data of video pictures 1, 2, and 3 are different from each other. When audio data of video pictures 1 to 3 are independently present, video pictures 1 to 3 need not be seamlessly switched. In such case, it is rather preferable to non-seamlessly switch video pictures by slightly returning to a start point of a video picture as a destination upon switching video pictures (otherwise, initial audio of a destination video picture may be interrupted).

Upon recording video pictures 1 to 3 as non-seamless angle data, recording of video picture (VOB1) to video picture (VOB3) on a disc is done for respective video object units (VOBU), as exemplified in FIG. 6(b). This recording method is used in video recording of non-seamless angle cells in the existing read-only DVD-video (the jump destination VOBU addresses upon non-seamless angle switching are described in playback control information PCI of navigation packs).

When multi-view video picture data is recorded on DVD in the multi-angle format, whether or not the multi-view video picture data is to be recorded as seamless or non-seamless angle data can be automatically determined by checking if common audio data is appended to a plurality of video pictures, as described above. Also, seamless or non-seamless angle data may be arbitrarily determined by the user. That is, the system may be configured to allow the user to select seamless angle recording even when common audio data is appended to a plurality of video pictures or seamless angle recording even when audio data are independently appended to a plurality of video pictures (e.g., a user menu that allows such user's choice may be formed).

Whether or not “common audio data is appended to a plurality of video pictures” can be determined by checking “if an audio stream is common in a component group descriptor in the PMT of digital broadcast”. In a broader sense, whether or not respective multi-view video pictures to be recorded have the same audio stream number (or ID) can be checked to determine if common audio data is appended.

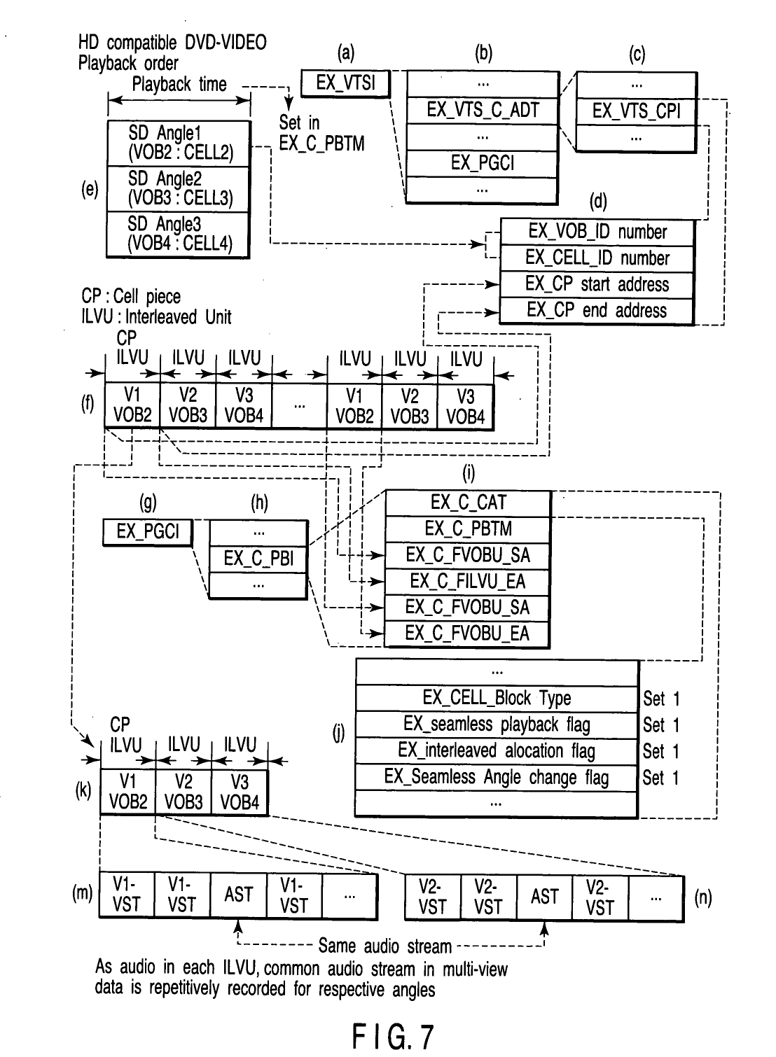

FIG. 7 is a view for explaining an example of the data structure upon converting multi-view data into seamless angle data of DVD-video (an audio stream is common to respective views). In case of seamless, recording is done in the order of the seamless angle example of FIG. 5(a) and FIG. 6(a) (in the order of V1→V2→V3 for respective ILVUs to have standard SD image quality), playback is made in the playback order shown in FIG. 5(b) (e.g., VOB1→angle 1 (VOB2) with SD image quality→VOB5: (angles 1, 2, and 3 are switchable)), and management information is set, as shown in FIG. 7.

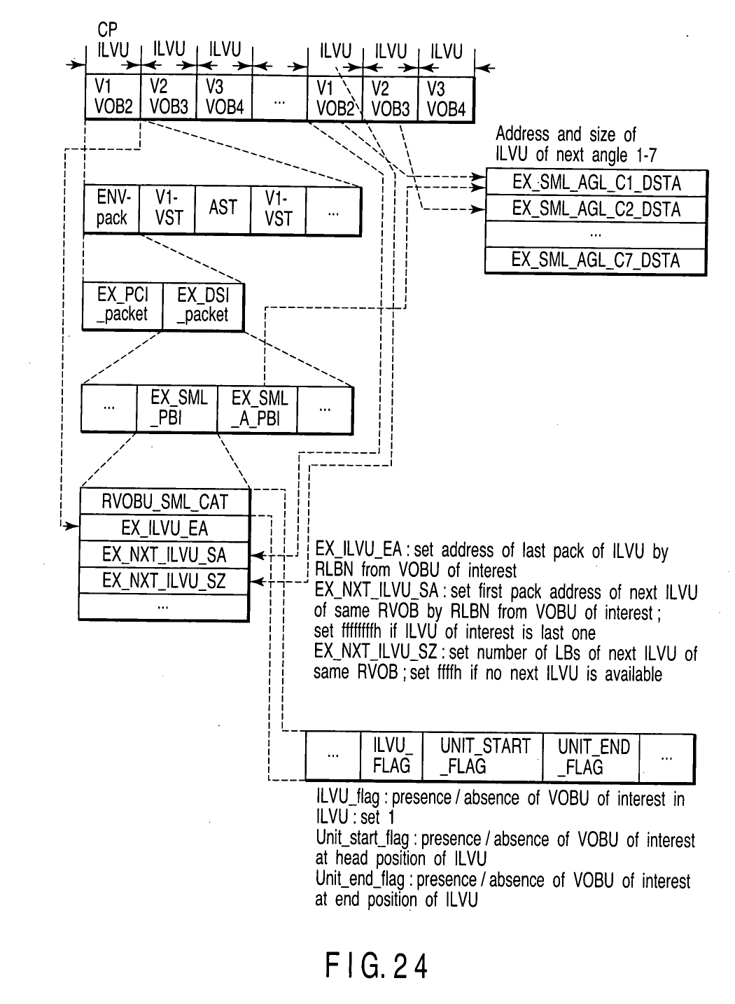

Recording on a disc (FIGS. 7(f), (k), (m), and (n)) is done for respective ILVUs in correspondence with the number of views of multi-view video pictures to have a nested structure. As shown in FIG. 24, each ILVU includes one or more VOBUs. At the head of each VOBU, an extended (EXtended) navigation pack (ENV pack) is allocated, and this ENV pack stores extended data search information EX_DSI and extended playback control information EX_PCI. The ILVU with such structure is a unit with a size that does not interrupt a view video picture until the next ILVU, and the limitation on the size can follow the method determined by the DVD-video standard. However, when a medium used in recording is renewed in case of, e.g., next-generation DVD, and has different performance, the ILVU value to be used must be changed.

Video attribute information and audio attribute information are set in video attribute VTS_V_ATR, audio attribute VTS_A_ATR, and the like in management information (not shown; video title set information VTSI) on the basis of information (descriptors) stored in SI and PSI. The ILVU is equal to a CP (Cell Piece) and information EX_VTS_CPI (FIG. 7(c)) of that CP stores the start and end addresses for each CP (FIG. 7(d)). A group of CPs forms a cell (CELL2 in FIG. 7(e), etc.) as a minimum playback unit.

EX_SML_PBI (seamless playback information) and EX_SML_AGLI (seamless angle information) are stored in an EX_DSI packet (FIG. 24) in the ENV pack to implement the seamless angle function. EX_SML_PBI stores RVOBU_SML_CAT (seamless category information of RVOBU), EX_ILVU_EA (end address information of ILVU), EX_NXT_ILVU_SA (start address information of ILVU), and EX_ILVU_SZ (size information of ILVU). RVOBU_SML_CAT stores ILVU_flag (a flag indicating the presence/absence of VOBU in ILVU: 1 if it is present), Unit_start_flag (a flag indicating the presence/absence of corresponding VOBU at the head of ILVU), and Unit_end_flag (a flag indicating the presence/absence of corresponding VOBU at the terminal end of ILVU), and these flags are set with corresponding values (1 if they are present; otherwise, 0). EX_ILVU_EA sets the address of the last pack of ILVU using a relative logical block number (RLBN), and EX_NXT_ILVU_SA and EX_ILVU_SZ respectively set the start address and size of the next ILVU of identical RVOB. EX_SML_AGLI is set with the address and size of the first ILVU of each angle which can be played back next to the corresponding ILVU.

If the corresponding ILVU is the last one in the angle playback period of interest, “fffffffh” is set in EX_NXT_ILVU_SA. Also, if the corresponding ILVU is the last one in the angle playback period of interest, no next ILVU is available, and “ffffh” is set in EX_ILVU_SZ in such case.

In EX_PGC information (FIG. 7(g) to (j)) as playback order information, “1” indicating an angle block is set in EX_CELL_BLOCK_TYPE in EX_C_CAT, “1” indicating seamless playback is set in EX_seamless playback flag, “1” indicating an interleaved block is set in EX_interleaved allocation flag, and “1” indicating seamless angle is set in EX_Seamless angle change flag. In addition, address information of first VOB is set in EX_FVOBU_SA, end address information of first ILVU is set in EX_C_FILVU_EA, start address information of the last VOBU is set in EX_C_FVOBU_SA, and end address information of the last VOBU is set in EX_C FVOBU_EA.

In this case, one angle is assigned to each view of multi-view video pictures, and includes 1 VOB·1 CELL (more specifically, in FIG. 7(e), angle 1 is formed of VOB2, which corresponds to CELL2, and so forth). In an NV pack, the addresses of the next ILVUs are set in seamless angle information (SML_AGLI) of DSI in correspondence with the number of angles. Zero is set in a non-existing angle to indicate the absence of the angle.

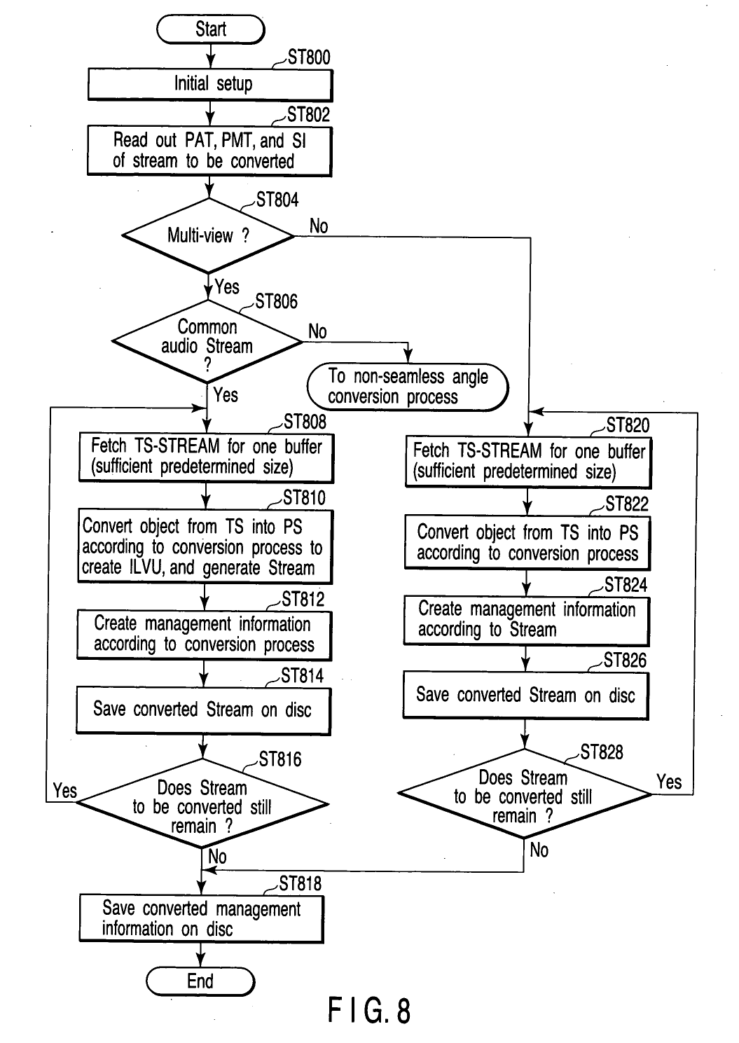

FIG. 8 is a flowchart for explaining an example of the operation upon converting multi-view data into seamless angle data of DVD-video (an audio stream is common to respective views). The actual operation is made as follows.

1) Various initial setups are made (step ST800), and the PAT (Program Association Table), PMT (Program Map Table), and SI (Service Information) in a stream to be converted are read out (step ST802).

2) It is checked based on the PMT, SI, and the like if the stream to be converted is multi-view broadcast (or rain attenuation broadcast) (step ST804). If the stream to be converted is not multi-view broadcast (NO in step ST804), the flow jumps to 10).

3) If the stream to be converted is multi-view broadcast (or rain attenuation broadcast), it is checked based on a component group descriptor of the PMT if an audio stream is common (step ST806). If an audio stream is not common (NO in step ST806), the flow advances to a non-seamless angle process.

4) If an audio stream is common (YES in step ST806), a TS stream is fetched for a given size (for one buffer) (step ST808).

5) TS-PS conversion is made by the method shown in FIGS. 4 to 6 to form ILVUs (Interleaved Units) so as to attain seamless payback, thus forming a stream (step ST810).

6) Management information conversion shown in, e.g., FIGS. 7 and 24 is made to create management information (step ST812).

7) The converted stream is saved on a disc (step ST814).

8) It is checked if streams to be converted still remain (step ST816). If streams to be converted still remain (YES in step ST816), the flow returns to step ST808.

9) If no stream to be converted remains (NO in step ST816), the converted management information is saved on the disc (step ST818), thus ending this process.

10) On the other hand, if the stream to be converted is not multi-view broadcast (NO in step ST804), a TS stream is fetched for a predetermined size (for one buffer) (step ST820).

11) A PS-TS conversion process shown in FIG. 4 is made (step ST822), and management information is created according to the stream (step ST824).

12) The converted stream is saved on a disc (step ST826), and it is checked if streams to be converted still remain (step ST828). If streams to be converted still remain (YES in step ST828), the flow returns to step ST820; otherwise (NO in step ST828), the flow advances to step ST818.

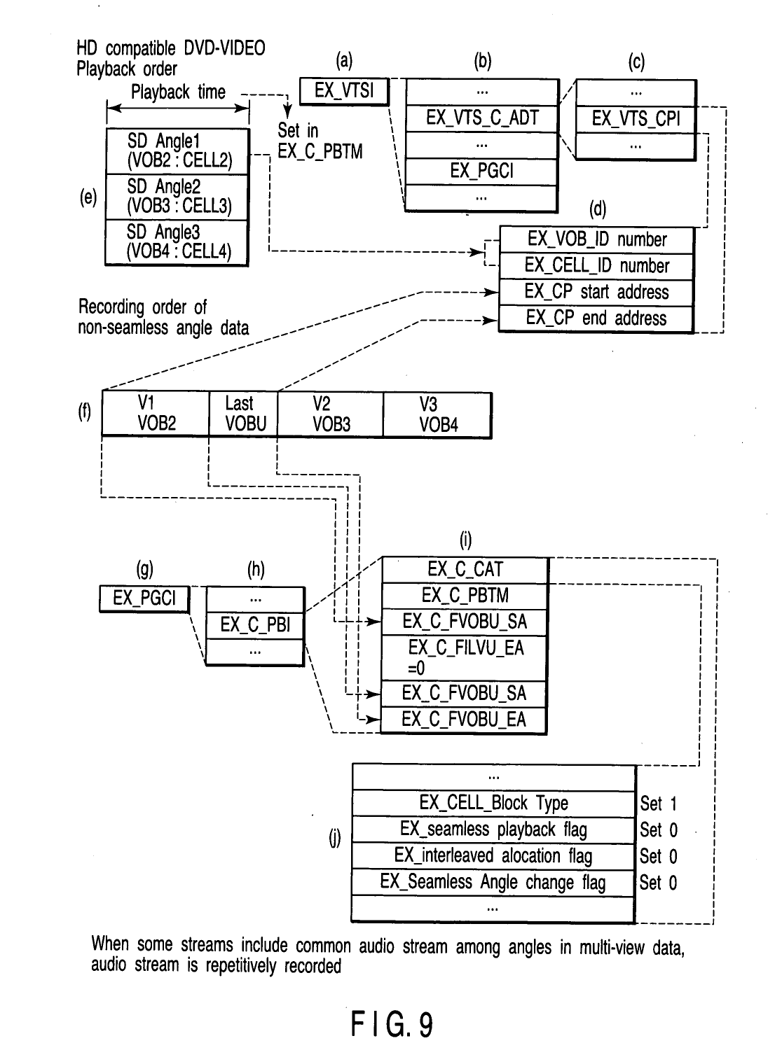

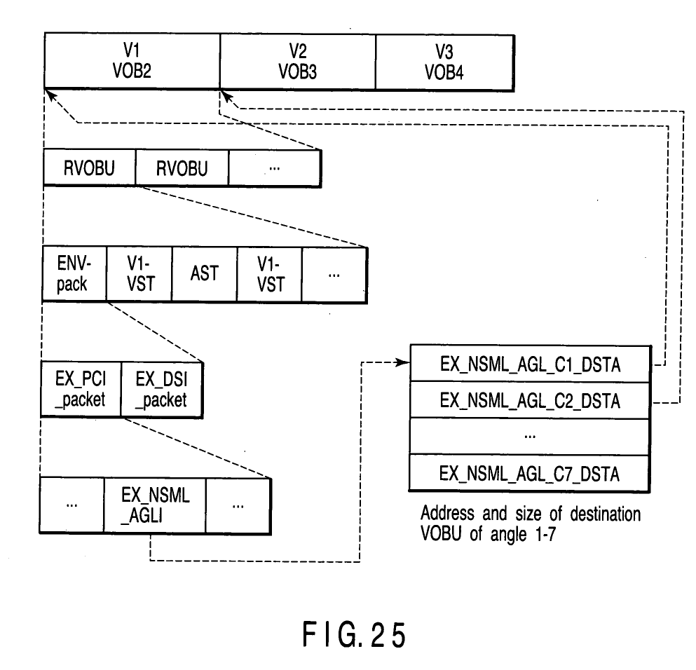

FIG. 9 is a view for explaining an example of the data structure upon converting multi-view data into non-seamless angle data of DVD-video (audio streams are appended to respective views). In case of non-seamless, recording is done in the order of the non-seamless angle example of FIG. 5(a) and FIG. 6(b) (in the order of V1→V2→V3 to have standard SD image quality), playback is made in the playback order shown in FIG. 5(b) (e.g., VOB1→angle 1 (VOB2) with SD image quality→VOB4 (angle 1 can be switched to angle 2 (VOB3) and angle 3 (VOB4))), and management information is set, as shown in FIGS. 9 and 25.

More specifically, in FIG. 25, for example, VOB2 of video picture V1 includes one or more RVOBUs, an ENV pack is allocated at the head of each RVOBU, and packs of video and audio streams and the like of video picture V1 are allocated after this ENV pack. The ENV pack includes extended playback information packet EX_PCI_packet and extended data search information packet EX_DSI_packet. This EX_PCI_packet stores extended non-seamless angle information EX_NSML_AGLI. This EX_NSML_AGLI stores a plurality of pieces of destination (jump destination) address information and size information (EX_NSML_AGL_C1_DSTA to EX_NSML_AGL_C7_DSTA) in correspondence with the number of angles (seven angles in the example of FIG. 25).

In case of non-seamless angle, recording of multi-view data (FIG. 9(e)) on a disc is made for respective VOBs (FIG. 9(f)). Attribute information values are set in VTS_V_ATR, VTS_A_ATR, and the like on the basis of information (descriptors) stored in SI and PSI. A cell piece (CP) becomes equal to a CELL since a normal process is done, and the start and end addresses of VOB are stored in EX_VTS_CPI as information of that CP (FIGS. 9(c) and (d)).

In EX_PGC information (FIG. 9(g) to (j)) as playback order information, “1” indicating an angle block is set in EX_CELL_BLOCK_TYPE in EX_C_CAT, “0” indicating non-seamless playback is set in EX_seamless playback flag, “0” indicating not an interleaved block is set in EX_interleaved allocation flag, and “0” indicating non-seamless angle is set in EX_Seamless angle change flag. In addition, address information of first VOB is set in EX_FVOBU_SA, end address information of first ILVU is set in EX_C_FILVU_EA, start address information of the last VOBU is set in EX_C_FVOBU_SA, and end address information of the last VOBU is set in EX_C_FVOBU_EA.

In this case, one angle is assigned to each view, and includes one VOB/one CELL (in FIG. 9(e), angle 1 is formed of VOB2, which corresponds to CELL2, and so forth). In an NV pack, the addresses and sizes of first VOBUs of respective angles are set in non-seamless angle information (EX_NSML_AGLI) in the EX_PCI packet in correspondence with the number of angles. Zero is set in a non-existing angle to indicate the absence of the angle.

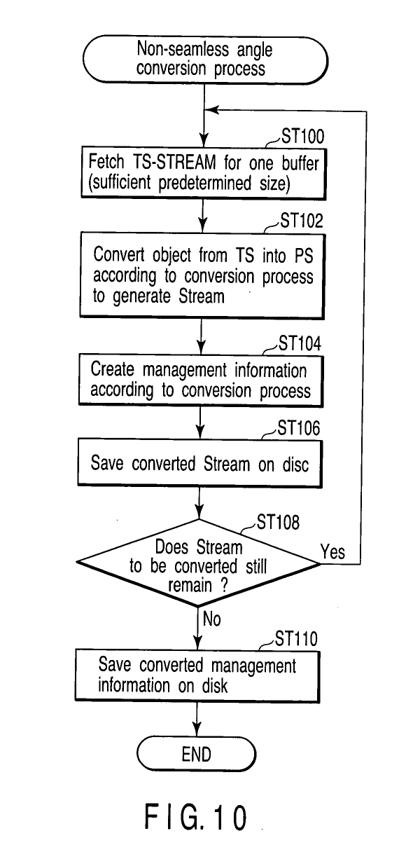

FIG. 10 is a flowchart for explaining an example of the operation upon converting multi-view data into non-seamless angle data of DVD-video (audio streams are appended to respective views). The actual operation is made as follows.

1) A TS stream is fetched for a predetermined size (for one buffer) (step ST100).

2) TS-PS conversion is made by the method shown in FIGS. 4 to 6 to form streams in the order of V1Stream, V2Stream, and V3Stream (V1 to V3 are respective views) (step ST102).

3) Management information conversion shown in, e.g., FIG. 9 is made to create management information (step ST104).

4) The converted stream is saved on a disc (step ST106)

5) It is checked if streams to be converted still remain (step ST108). If streams to be converted still remain (YES in step ST108), the flow returns to step ST100.

6) If no stream to be converted remains (NO in step ST108), the converted management information is saved on the disc (step ST110), thus ending this process.

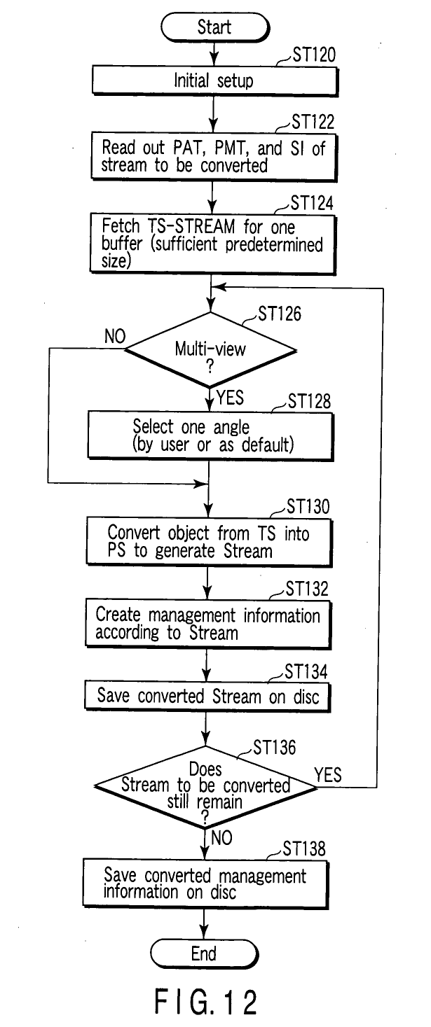

FIG. 11 is a view for explaining a case wherein one view data is selected from multi-view (or rain attenuation) data and is recorded/played back (an example of high-definition compatible DVD-video). When multi-view broadcast is converted into DVD-video and the converted data is saved, two methods are available. The first method (method of multi-angle recording all views of multi-view broadcast) has been described above using FIG. 5. The second method allows the user to select only one view to be seen from the multi-view broadcast (or firmware of MPU 80 in FIG. 3 selects one view as a default), records that view as VOB, and registers it in PGC, as shown in FIGS. 11(a) and (b). In this case, after one view to be recorded is selected, the same steps as those in a normal video recording process are executed. The actual operation is made, as shown in FIG. 12.

1) Various initial setups are made (step ST120), and the PAT (Program Association Table), PMT (Program Map Table), and SI (Service Information) in a stream to be converted are read out (step ST122).

2) A TS stream is fetched for a given size (for one buffer) (step ST124).

3) It is checked based on the PMT, SI, and the like if the stream to be converted is multi-view broadcast (or rain attenuation broadcast) (step ST126). If the stream to be converted is not multi-view broadcast (NO in step ST126), the flow jumps to step ST130.

4) If the stream to be converted is multi-view broadcast (or rain attenuation broadcast) (YES in step ST126), one view is selected, as shown in FIG. 11 (one view is selected by the user or as a default), and is set to be recorded (step ST128).

5) The stream is converted from TS to PS by the method shown in FIGS. 4 to 6 to form a stream (step ST130).

6) Management information conversion is made according to the streams to create management information (step ST132).

7) The converted stream is saved on a disc (step ST134).

8) It is checked if streams to be converted still remain (step ST136). If streams to be converted still remain (YES in step ST136), the flow returns to step ST126.

9) If no stream to be converted remains (NO in step ST136), the converted management information is saved on the disc (step ST138), thus ending this process.

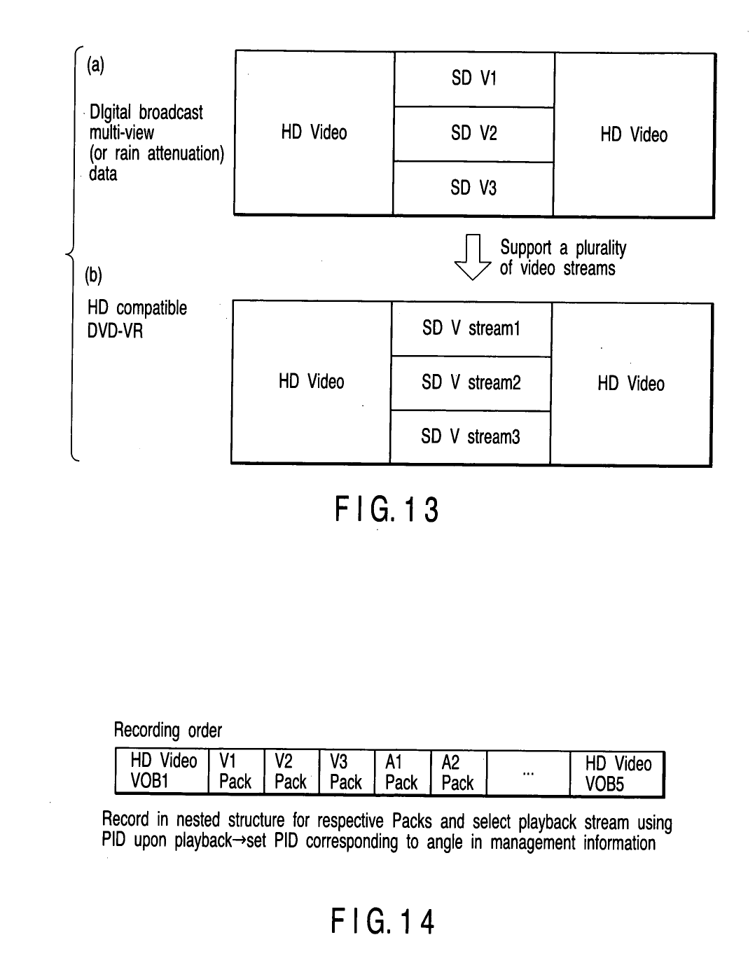

FIG. 13 is a view for explaining a case wherein multi-view (or rain attenuation) data of digital TV broadcast is converted into a plurality of DVD-video recording streams (high-definition compatible), and the converted streams are recorded/played back. FIG. 14 is a view for explaining an example of the structure of video objects in case of FIG. 13 (an example that records a plurality of streams for respective packs in a nested structure).

When multi-view broadcast (or rain attenuation broadcast) is converted into the video recording standard (DVD-VR) format and the converted data is saved, three different methods (two different methods with format changes, and one method without format change) are available.

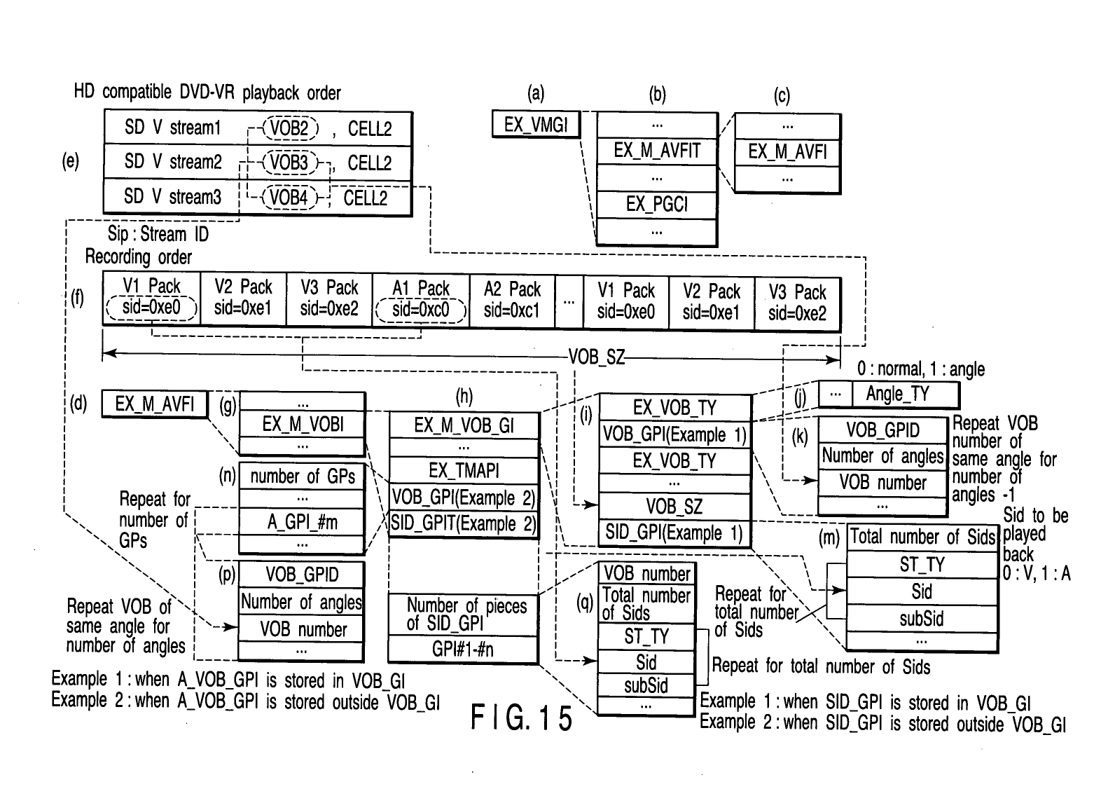

The first method defines special VOB called angle VOB for a view. In order to store a plurality of angles in this angle VOB, a plurality of video pictures (V1 to V3 in the example of FIGS. 13 and 14) identified by PID (Packet Identification) are allowed to be present together, and combinations of angle objects to be played back are determined by group information (VOP_GPI, SID_GPI, and the like in FIGS. 15(h) and (i)). In this case, information to be changed includes objects and some pieces of management information (EX_M_VOBI in FIG. 15 and EX_PGCI in FIG. 16).

FIG. 15 is a view for explaining an example of the data structure (configuration 1 of management information) upon converting multi-view data into the DVD-video recording format. As shown in FIG. 15(f), objects (e.g., V1 to V3) are multiplexed (superposed) for respective packs, and are segmented by SID (StreamID) such as “sid=0×e0” and the like. Alternatively, as a private stream of SID, objects may be segmented by SubSID. Especially, an audio stream which is supported by the existing DVD format poses no problem, but an audio stream of an unsupported type is coped with by determining new SID or SubSID.

FIG. 16 is a view for explaining an example of the data structure (configuration 2 of management information) upon converting multi-view data into the DVD-video recording format. As shown in FIGS. 16(a) and (f), control information pack CTLPack (option) is added at the head position, and copy management information (CPI) and display control information (DCI) are stored in correspondence with the number of angles. Hence, each display control information general information DCI_GI and copy control information general information CCI_GI store the number of angles. Alternatively, control information general information CTL-GI may store the number of angles, and CCI and DCI may be set in correspondence with the number of angles.

In this case, the management information is set as follows. EX_M_VOBI in FIG. 15 stores a flag indicating angle VOB in EX_VOB_TY (FIG. 15(g) to (j)). Also, VOB_GPI and SID_GPI (FIG. 15(h) or 15(i)) are required.

If EX_M_VOB_GI includes VOB_GPI and SID_GPI (example 1), VOB_GPI (FIG. 15(k)) has a structure in which the number of angles is allocated at its head position, and the numbers (VOB_ID) of VOBs other than the self VOB are set. SID_GPI (FIG. 15(m)) has a structure in which the number of objects is allocated at its head position, and stream type ST_TY indicating whether the stream is video (V) or audio (A), stream identifier SID, and sub-stream identifier SubSID are set after the number of objects. (Example: in case of V1 PACK, ST_TY=0 and SID=0×e0; in case of A1 PACK, ST_TY=1 and SID=0×c0.) As for SubSID, zero is described if it is not set.

If VOB_GPI and SID_GPI are present outside EX_M_VOB_GI (example 2), VOB_GPI (FIG. 15(n)) has a structure in which the number of angles is allocated at its head position. In each of the GPIs (FIG. 15(p)), VOB numbers (VOB_ID) are set after the number of angles. In SID_GPIT (FIG. 15(h)), the number of pieces of SID_GPI (FIG. 15(q)) is set at its head position, and a plurality of pieces of SID_GPI are allocated in correspondence with that number. Also, SID_GPI (FIG. 15(q)) has a structure in which the corresponding VOB number is set at its head position, and the number of objects to be played back (the total number of SID), ST_TY, SID, and SubSID are set after the VOB number. (Example: in case of V1 PACK, ST_TY=0 and SID=0×e0; in case of A1 PACK, ST_TY=1 and SID=0×c0.) As for SubSID, zero is described if it is not set.

In EX_VOBU_ENTI (FIGS. 16(c) and (d)) in each EX_TMAPI (FIG. 16(b)), EX_{—}1STREF_SZ defines a size from the head of each VOB (from CTL_Pack; from the head if it is not available) to the end of I-picture data of each VOB, and VOBU_SZ defines a size from the head of each VOB to the end of each VOBU. The end of each VOBU is not always a video pack and may be an audio pack. (EX_VOBU_PB_TM in FIG. 16(d) indicates the playback time of the VOBU of interest.) Note that a VOB group registered as an angle is called VOB_GP, and is set in a CELL for each VOP_GP.

In cell information EX_CI in EX_PGCI (FIG. 16(g) to (m)) as playback information, a flag (ANGLE_C_FLAG) used to check if this cell is an angle cell is allocated in EX_C_TY, and an EX_VOB_GP number (a recording order in VOB_GPI or VOB_GPID) is set after that flag. Furthermore, entry point information EX_C_EPI is set with the VOB number and playback time EP_PTM of the entry point of interest.

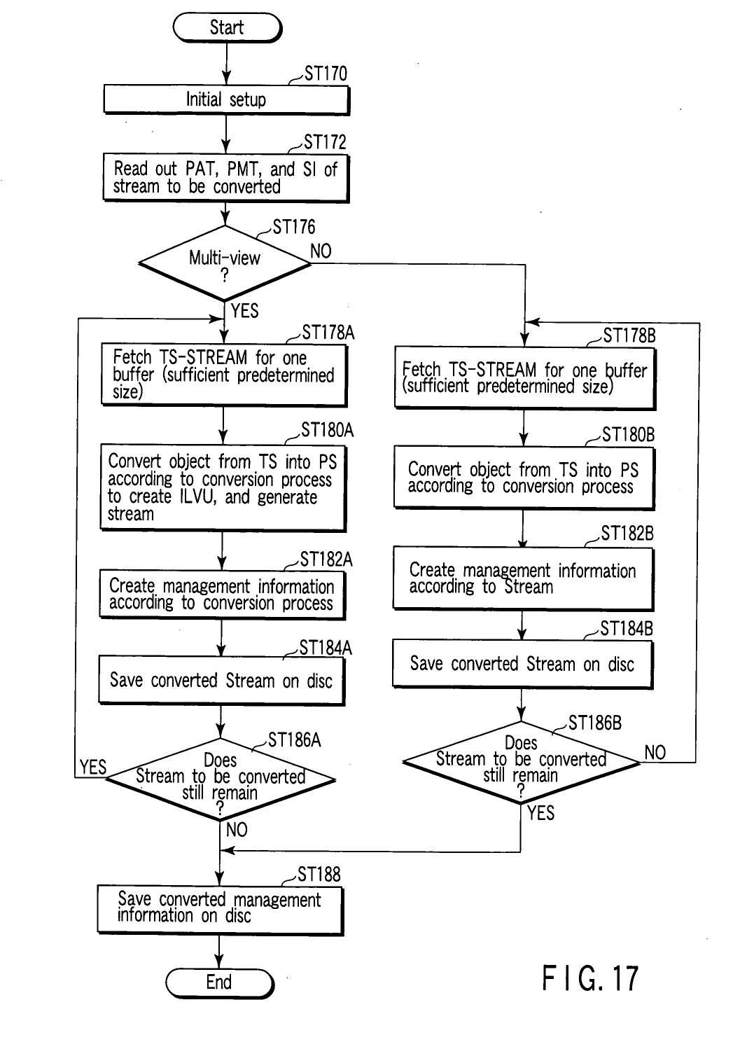

FIG. 17 is a flowchart for explaining an example of the operation upon converting multi-view data into the DVD-video recording format (an example using a plurality of streams). The actual operation is done as follows.

1) Various initial setups are made (step ST170), and the PAT (Program Association Table), PMT (Program Map Table), and SI (Service Information) in a stream to be converted are read out (step ST172).

2) It is checked based on the PMT, SI, and the like if the stream to be converted is multi-view broadcast (or rain attenuation broadcast) (step ST176). If the stream to be converted is not multi-view broadcast (NO in step ST176), the flow advances to step ST178B.

3) If the stream to be converted is multi-view broadcast (or rain attenuation broadcast) (YES in step ST176), a TS stream is fetched for a given size (for one buffer) (step ST178A).

4) TS-PS conversion of the stream is made by the method shown in FIGS. 4 to 14 to form a stream by re-assigning PIDs so as to prevent video and audio streams from overlapping in each view (step ST180A).

5) Management information conversion shown in FIGS. 15 and 16 is made to create management information (step ST182A). Note that an angle group is formed for each view, and the PIDs for respective angles are registered in each group.

6) The converted stream is saved on a disc (step ST184A).

7) It is checked if streams to be converted still remain (step ST186A). If streams to be converted still remain (YES in step ST186A), the flow returns to step ST178A.

8) If no stream to be converted remains (NO in step ST186A), the converted management information is saved on the disc (step ST188), thus ending this process.

9) On the other hand, if the stream to be converted is not multi-view broadcast (YES in step ST176), a TS stream is fetched for a predetermined size (for one buffer) (step ST178B).

10) A PS-TS conversion process shown in FIGS. 4 and 14 is made (step ST180B), and management information is created according to the stream (step ST182B).

11) The converted stream is saved on a disc (step ST184B), and it is checked if streams to be converted still remain (step ST186B). If streams to be converted still remain (YES in step ST186B), the flow returns to step ST178B; otherwise (NO in step ST186B), the flow advances to step ST188.

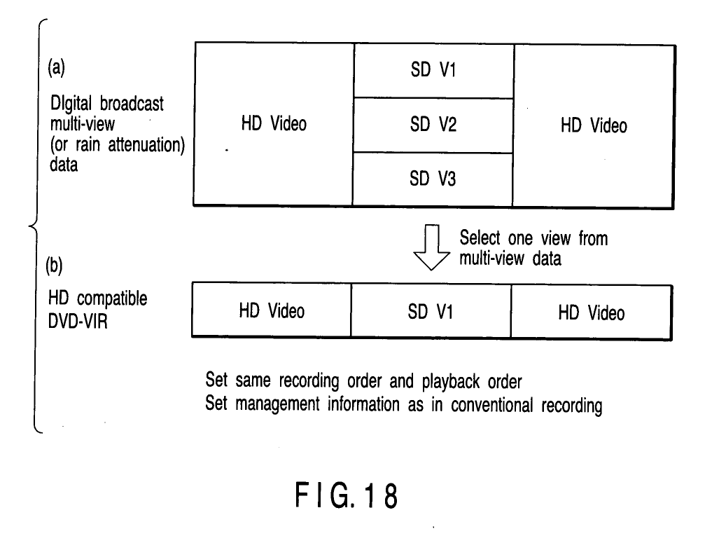

FIG. 18 is a view for explaining a case wherein one view data is selected from multi-view (or rain attenuation) data and is recorded/played back (an example of high-definition compatible DVD-video recording). In the second method used when multi-view broadcast (or rain attenuation broadcast) is converted into the video recording standard (DVD-VR) format and the converted data is saved, the user (or firmware of the control MPU) selects only one view to be seen of multi-view broadcast, and that view is registered as VOB and is registered in PGC. In this case, after one view to be recorded is selected, the same steps as those in a normal video recording process are executed.

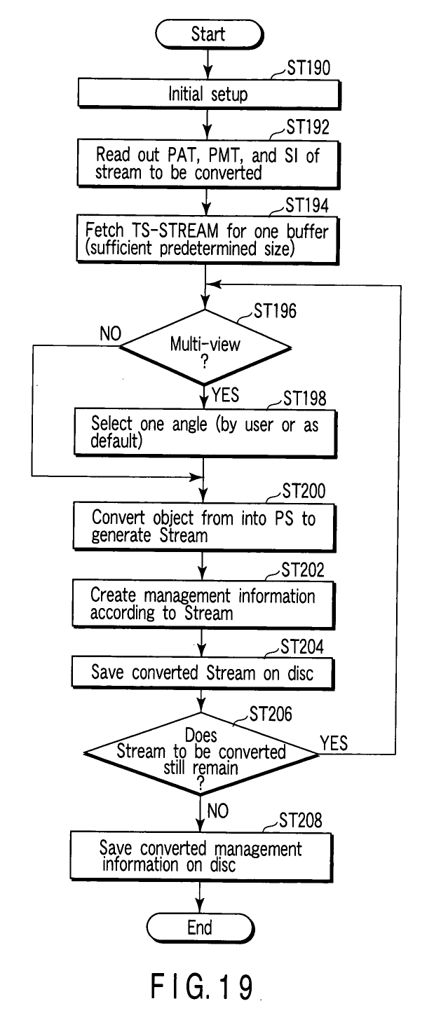

FIG. 19 is a flowchart for explaining another example of the operation upon converting multi-view data into the DVD-video recording format (an example that records one selected view in one stream). The actual operation is made as follows.

1) Various initial setups are made (step ST190), and the PAT (Program Association Table), PMT (Program Map Table), and SI (Service Information) in a stream to be converted are read out (step ST192).

2) A TS stream is fetched for a given size (for one buffer) (step ST194).

3) It is checked based on the PMT, SI, and the like if the stream to be converted is multi-view broadcast (or rain attenuation broadcast) (step ST196). If the stream to be converted is not multi-view broadcast (NO in step ST196), the flow advances to step ST200.

4) One view is selected, as shown in FIG. 18 (selected by the user or as a default), and an angle to be recorded is determined and set (step ST198).

5) The stream is converted from TS to PS by the method shown in FIG. 4 to form a stream (step ST200).

6) Management information is created according to the stream (step ST202).

7) The converted stream is saved on a disc (step ST204).

8) It is checked if streams to be converted still remain (step ST206). If streams to be converted still remain (YES in step ST206), the flow returns to step ST196.

9) If no stream to be converted remains (NO in step ST206), the converted management information is saved on the disc (step ST208), thus ending this process.

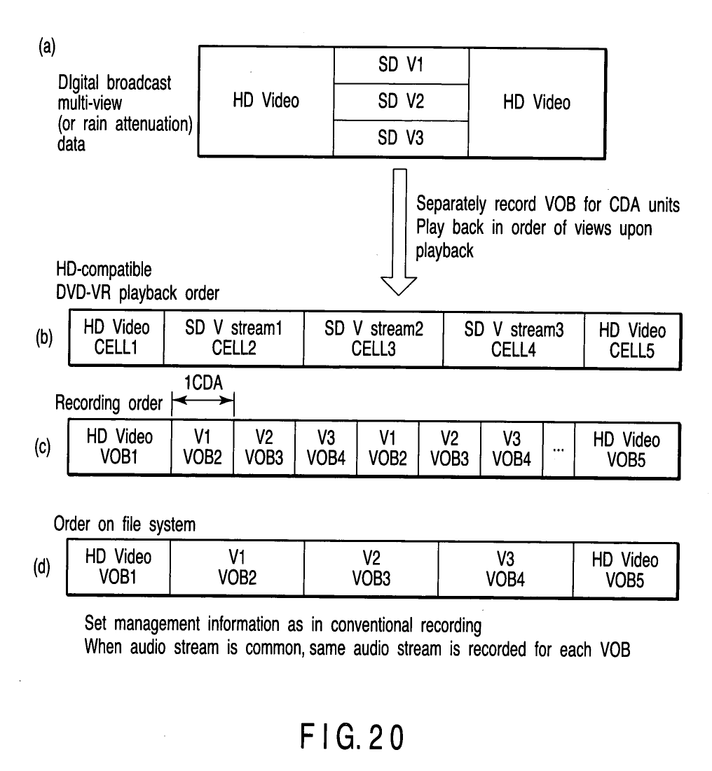

FIG. 20 is a view for explaining an example of the structure of video objects when multi-view (or rain attenuation) data of digital TV broadcast is converted into a plurality of DVD-video recording (high-definition compatible) streams, and the converted streams are recorded/played back.

In the third method used when multi-view broadcast (or rain attenuation broadcast) is converted into the video recording standard (DVD-VR) format and the converted data is saved, all views of multi-view broadcast are recorded and seen successively. With this method, the user can watch all angles, and recording and playback can be made without any format change in terms of management. When recording is made by the third method, respective views are recorded in a nested structure for respective CDAs (continuous recording areas), and are linked later by the file system.

For example, when all views V1 to V3 in FIG. 20(a) are recorded by the third method, VOB2 of view V1, VOB3 of view V2, and VOB4 of view V3 are periodically recorded in a nested sequence for one CDA, as shown in, e.g., FIG. 20(c). In this case, VOB2 data of view V1 are recorded intermittently for one CDA. However, upon playback, the file system manages VOB2 data of view V1 as one VOB so that a video picture of view V1 is played back continuously (see FIG. 20(d)). Likewise, the file system manages VOB3 data of view V2 as one VOB, and manages VOB4 data of view V3 as one VOB. As a result, all views (angles) V1 to V3 can be sequentially seen, but angle switching (seamless or non-seamless arbitrary playback among VOB2 and VOB3) and the like are not available unlike DVD-video.

When entry points are set in VOB2 to VOB4 and that entry point information EPI (FIG. 16(i)) is written in management information (EX_PGCI), switching playback of VOB2 to VOB4 can be non-seamlessly made using the entry points. That is, in cell information EX_CI in program chain information EX_PGCI in the management information shown in FIG. 16(g) to (m), a flag used to check if the corresponding cell is an angle cell is allocated in EX_C_TY, and the VOB number and playback time EP_PTM of the entry point of interest are set in entry point information EX_C_EPI. For example, if the user inputs an entry point (marker) corresponding to this entry point information (EX_C_EPI) during angle playback (or if MPU 80 in FIG. 3 automatically assigns it to the head position of each VOB of an angle part), the playback start position can be freely switched using this entry point as a target. For this reason, non-seamless angle switching using the entry points can be performed.

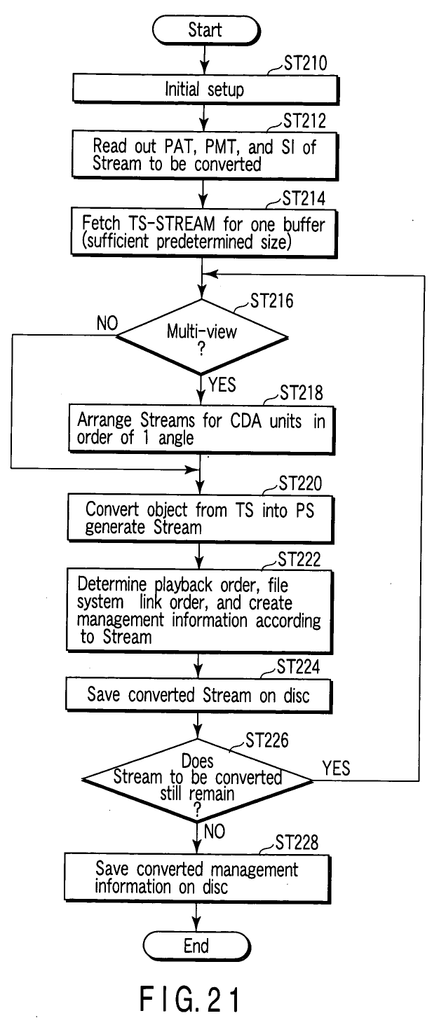

FIG. 21 is a flowchart for explaining still another example of the operation upon converting multi-view data into the DVD-video recording format. The actual operation is made as follows.

1) Various initial setups are made (step ST210), and the PAT (Program Association Table), PMT (Program Map Table), and SI (Service Information) in a stream to be converted are read out (step ST212).

2) A TS stream is fetched for a given size (for one buffer) (step ST214).

3) It is checked based on the PMT, SI, and the like if the stream to be converted is multi-view broadcast (or rain attenuation broadcast) (step ST216). If the stream to be converted is not multi-view broadcast (NO in step ST216), the flow advances to step ST220.

4) As shown in, e.g., FIG. 20, VOB2 to VOB4 of respective views are arranged in the order of angles for respective CDAs to form a stream (step ST218).

5) The stream is converted from TS to PS by the method shown in FIG. 4 to form a stream (step ST220).

6) Management information is created according to the stream (step ST222). In this case, the playback order of objects of respective views, which are recorded in a nested structure for respective CDAs (continuous recording areas), is determined, and respective views are linked by the file system (see FIG. 20(d)).

7) The converted stream is saved on a disc (step ST224).

8) It is checked if streams to be converted still remain (step ST226). If streams to be converted still remain (YES in step ST226), the flow returns to step ST216.

9) If no stream to be converted remains (NO in step ST226), the converted management information is saved on the disc (step ST228), thus ending this process.

FIG. 22 is a view for explaining an example of how to record management information (control information) and the like of digital broadcast in the DVD-video format. Upon saving SI, PSI, and DATA broadcast information as management information of digital broadcast, in the DVD-video format, as shown in FIG. 22, text information of each information is stored in IT_TXT, and audio attribute information and video attribute information are stored in ATR of each title. Other kinds of information are saved by defining new PSIPack and DATAPack. For example, since PSIPack is control information, it is set as private stream 2 (SID=10111111b) defined for control in DVD to be distinguished from PCI and DSI using SubID. Since DATA broadcast data is contents data, it is set as private stream 1 (SID=10111101b) defined for contents information in DVD to be distinguished from A_Pack and SP_Pack using SubID.

Copy control information is saved as extended information in PCIPack in NVPack. More specifically, VOBU category EX_PCI_VOBU_CAT is provided to PCI general information (not shown) of the NV pack to store digital copy information CGMS (00=copy free, 01=copy once, 10=copy never), EPN (0 contents protection, 1=no contents protection), and ICT (0=analog video output resolution constraint, 1=no constraint) together with APS (Analog Protection System).

FIG. 23 is a view for explaining an example of how to record management information (control information) and the like of digital broadcast in the DVD-video recording format. SI, PSI, and DATA broadcast information as management information of digital broadcast are saved, as shown in, e.g., FIG. 23, in case of the DVD-VR format. That is, of text information, program name-related information is set in primary text PRM_TXT in program information PGI, other kinds of text information are set in text item IT_TXT, and audio attribute information and video attribute information are set in stream information STI of each VOB. Other kinds of information are saved by defining new PSIPack and DATAPack. At this time, for example, since PSIPack is control information, it is set as private stream 2 (SID=10111111b) defined for control in DVD to be distinguished from CLTPack using SubID.

Since DATA broadcast data is contents data, it is set as private stream 1 (SID=10111101b) defined for contents information in DVD to be distinguished from A_Pack and SP_Pack using SubID. Furthermore, copy control information is saved as extended information in CCI in CTLPack. CTL_Pack includes EPN (0 contents protection, 1=no contents protection), and ICT (0=analog video output resolution constraint, 1=no constraint) together with APS and CGMS.

### Summary of Gist of Embodiment

(a) Upon DVD-recording digital broadcast, multi-view broadcast data is recorded as multi-angle (MPEG-PS) data in the DVD-video standard.

(b) If an audio stream is common to respective angles in “(a)”, multi-view broadcast data is recorded as seamless angle data.

(c) If an audio stream is not common to respective angles in “(a)”, multi-view broadcast data is recorded as non-seamless angle data.

(d) Upon DVD-recording digital broadcast, selecting and recording one view of multi-view broadcast data is adopted as a possible choice.

(e) Upon DVD-recording digital broadcast, if multi-view broadcast data is saved on a DVD disc in the DVD-VR standard (MPEG-PS), the multi-view broadcast data is recorded as a plurality of video streams. In order to support the plurality of video streams, SID group information and angle VOB information are prepared, and VOB_GPID is designated by playback information (CI).

(f) Upon DVD-recording digital broadcast, if multi-view broadcast data is saved on a DVD disc in the DVD-VR standard (MPEG-PS), recording data is separately recorded for predetermined sizes (CDA), and playback order information is configured to play back view moving pictures in a given order upon playback.

(g) Upon recording digital broadcast on a DVD disc in the DVD-video standard, each program-related information in SI and PSI of digital broadcast is recorded in IT_TXT, video attribute information and audio attribute information are recorded in VTSI_ATRI, and other kinds of information are saved as PSI_PACK.

(h) In “(g)”, DATA broadcast information is saved as DATA_PACK.

(i) Upon recording digital broadcast on a DVD disc in the DVD-video standard (MPEG-PS), each program-related information in SI and PSI of digital broadcast is recorded in PRM_TXT and IT_TXT, video attribute information and audio attribute information are recorded in STI, and other kinds of information are saved as PSI_PACK.

(j) In “(i)”, DATA broadcast information is saved as DATA_PACK.

### Effects of Embodiment

(1) When MPEG-TS of multi-view broadcast (or rain attenuation broadcast) is converted into MPEG-PS and is recorded/played back according to the aforementioned method, digital broadcast can be recorded and played back on and from an existing DVD. In the aforementioned embodiment, TS of digital broadcast is directly converted into PS. However, contents which have been temporarily recorded in a DVD streamer or HDD streamer as TS can be converted into PS later.

(2) After TS of digital broadcast is converted into PS, PS is recorded on a DVD-R, thus allowing a DVD player to play it back.

(3) When TS→PS conversion is made upon recording in the VR mode using a DVD-VR recorder, extra data (packet header of TS and the like) of digital broadcast can be omitted upon recording, and multi-recording of multi-view broadcast and rain attenuation broadcast can be made.

Note that the present invention is not limited to the aforementioned embodiments, and various modifications may be made on the basis of techniques available at that time without departing from the scope of the invention when it is practiced at present or in the future. The respective embodiments may be combined as needed as long as possible, and combined effects can be obtained in such case. Furthermore, the embodiments include inventions of various stages, and various inventions can be extracted by appropriately combining a plurality of required constituent elements disclosed in this application. For example, even when some required constituent elements are deleted from all the required constituent elements disclosed in the embodiments, an arrangement from which those required constituent elements are deleted can be extracted as an invention.

What is claimed is:

1. An information medium configured to record a digital stream signal including multi-view video picture or rain attenuation broadcast video picture data,
wherein the information medium has a management area and a data area,
the data area is configured to store the multi-view video picture or rain attenuation broadcast video picture data as multi-angle data, and
the management area is configured to store management information required to manage recording contents of the data area.

2. A recording method using an information medium which is configured to record a digital stream signal including multi-view video picture or rain attenuation broadcast video picture data, and in which the information medium has a management area and a data area, the data area is configured to store the multi-view video picture or rain attenuation broadcast video picture data as multi-angle data, and the management area is configured to store management information required to manage recording contents of the data area, comprising:
recording object data in the data area; and
recording the management information in the management area.

3. A playback method using an information medium which is configured to record a digital stream signal including multi-view video picture or rain attenuation broadcast video picture data, and in which the information medium has a management area and a data area, the data area is configured to store the multi-view video picture or rain attenuation broadcast video picture data as multi-angle data, and the management area is configured to store management information required to manage recording contents of the data area, comprising:
reproducing the management information from the management area; and
reproducing object data from the data area.

4. A recording apparatus using the information medium as defined in claim 1, said apparatus comprising:
a first recording unit configured to record object data in the data area; and
a second recording unit configured to record the management information in the management area.

5. A playback apparatus using the information medium as defined in claim 1, said apparatus comprising:
a first reproducing unit configured to reproduce the management information from the management area; and
a second reproducing unit configured to reproduce object data from the data area.

6. A medium according to claim 1, wherein the digital stream signal has a form of an MPEG transport stream signal, and the multi-angle data stored in the data area has a form of an MPEG program stream signal.

7. A medium according to claim 1, wherein the multi-view video picture data is formed of video pictures of a plurality of views, the video picture of each view includes a video stream and audio stream, and when the audio streams of some of the video pictures of the plurality of views are common to the audio streams of other video pictures of the plurality of views, the multi-view video data is stored as seamless multi-angle data in the data area.

8. A medium according to claim 1, wherein the multi-view video picture data is formed of video pictures of a plurality of views, the video picture of each view includes a video stream and audio stream, and when the audio streams of some of the video pictures of the plurality of views are not common to the audio streams of other video pictures of the plurality of views, the multi-view video data is stored as non-seamless multi-angle data in the data area.

9. A medium according to claim 1, wherein the multi-view video picture data is formed of video pictures of a plurality of views, and one of the video pictures of the plurality of views is stored in the data area.

10. A medium according to claim 1, wherein when the digital stream signal is an MPEG stream signal including service information or program specification information, contents of the service information or program specification information are converted into predetermined text data, and the converted text data is stored in the management area as some data of the management information.

11. A medium according to claim 1, wherein when the digital stream signal includes data broadcast information, the data broadcast information is stored in a predetermined data pack, and the data pack is recorded in the data area of the information medium.
